(19) United States
(12) Patent Application Publication
(10) Pub. No.: US 2014/0156733 A1
(43) Pub. Date: Jun. 5, 2014

(54) System and Method For Situated Reasoning With Information

(71) Applicant: Harold T. Goranson, Virginia Beach, VA (US)

(72) Inventor: Harold T. Goranson, Virginia Beach, VA (US)

(21) Appl. No.: 13/919,751

(22) Filed: Jun. 17, 2013

Related U.S. Application Data
(63) Continuation of application No. 12/798,487, filed on Apr. 5, 2010, now abandoned.

(51) Int. Cl. H04L 29/06

(52) U.S. Cl. CPC H04L 67/42
USPC 709/203

(57) ABSTRACT

The present invention provides a novel computer system that synthesizes object programming, functional programing and data-flow programming, with advances in mathematical logic and cognitive modeling. The synthesis allows a system to exist which provides for close alignment among the manner in which a user interacts with a system, how that interaction forms a dynamic working profile and how that profile is to be used, to guide on-the-fly, situation-specific ontological federation, presenting the user with a unified view of disparate information.

This application claims the benefits of the following U.S. patent applications: U.S. patent application Ser. No. 12/798,487 filed on Apr. 5, 2010, U.S. patent application Ser. No. 12/105,143 filed on Apr. 17, 2008 and U.S. Provisional patent application 61/166,579 filed on 3 Apr. 2009.

### FIELD OF THE INVENTION

The invention disclosed herein relates to a system architecture and method to allow a user to create situations and have information suitably presented as a result, such information collected from disparate sources, ontologically harmonized and suitably assembled for that situation.

### BACKGROUND OF THE INVENTION

Computer and other electronic information technologies exist to gather, comprehend and manipulate vast quantities of information. However, for most uses the information needs to be structured in order to be accessed and displayed. In general, the more sophisticated and complex these structures in the context of the problem to be addressed, the more useful they are. Computing systems have been used to structure this information, but the results have not been optimal. Information is often already well-structured before it is accessed, so it is difficult or impossible to anticipate the context of a particular use. Moreover, information differently controlled or generated in often different ways is structured using fundamentally different underlying structuring methods, technologies and ontologies. As a result, information is not well structured for many specialized uses, or uses that require merged information from diverse information sources.

A computing system accomplishes a task by taking information that may be stored, or may be streaming in from outside sources, performing some transforming operation on that information, assembling structures from that information as the methods allow and presenting the results to a user, either a human or another computing system. In the case of a human user, the display technology and methods significantly affect the insights that can be gleaned from these structures, and often constrain the nature of the structures themselves.

Such a system operates by locating relevant information, passing and transforming it, using physical and logical elements that are connected by communication devices; these can be within a distributed computer system or in the same physical device. For example, a system may consist of servers and clients that are in different locations and networked by communication devices, and a browser within a client, where the browser and support software are logically connected within the client device and connected to the system via a client communication device.

Servers may be comprised of server processors, server memory and associated communication devices which connect them for networked, perhaps collaborative processing. Clients may be composed of client processors and client memory with associated client communication devices. Computing systems may be composed of many servers and many clients in a network. A typical client is often singly connected to many servers in a server cloud, with a clear client-server boundary that delineates whether information is processed on a client processor or a server processor. A distributed system can be composed of at least one client and one server, but may be (and often is) composed of multiples of one or both clients and servers.

The computing elements, i.e., the servers and clients connected through the distributed system, each perform assigned smaller jobs, potentially simultaneously, to accomplish the overall task. The resulting aggregations of jobs can be seen by a user as applications such as,(but not limited to) rule evaluation, data retrieval or image recognition.

The system's overall task can be logically broken into smaller components of varying size; each smaller task can be assigned to a computing element. Typical computing operation involves messages among these smaller components, and many of these messages direct the location, passing and transformation of information, conveying the result as a structured whole.

Such messages may be from the user in an interaction with the computing system. These messages could be entered into the computing system by any input technology capable of creating or capturing user-initiated information. This user information could be then structured by the computing system and used as instructions. These instructions may be used to restructure the aforementioned structured information to better serve the user as communicated in the instructions. Such a case is called ‘situated information structuring,’ assuring that the information as presented to the user by the system is apt for the problem at hand.

Similar messages may originate in special purpose applications that perform a role similar to the human, but typically less nuanced and intuitive. These applications may be hosted in clients, servers or in special client communication devices.

Many elements, humans and applications may be simultaneously processing, structuring and sending information. Some components in the system will be concerned with creation of these messages in a compatible fashion; other components will be managing the flow of these messages; yet other components will be structuring information, and finally some components will be presenting the structures to humans and external applications.

Many additional messages will be entering the system from external information sources, providing raw and partially structured information. These can be from continuous or discrete sensors, for example television cameras or manufacturing plant monitors. They can also be from other computer systems that search, harvest and present information, like web crawlers. Or they can be other computing systems that have collected and structured information by independent means, and supply it to the system in question by subscription or query.

These sources will be using structuring techniques that may have been independently developed and use differing theoretical foundations. One such foundation is the structuring technology known as an ontology. Ontologies are formal, meaning logic-based, descriptions of the world in which the relevant information exists. Ontologies can be detailed and in a user-readable logic, or they can be simple and consist of data dictionary definitions and schemas. In this context, any method used to structure information is an ontology.

Ontologies need not, and usually do not conform one to another. Structured information using one ontology usually does not combine well with structured information using another. One challenge in these systems is the structuring of information from diverse sources to be ideally “situated” to the structure the user requires, based on information gleaned from the user and associated agents that presents the structure of the situation required.

A related challenge is in presenting interfaces for human and automated users such that this situation structure can be appropriately developed so as to guide the system in appropriately delivering structured results.

Another challenge is to perform the system structuring in near real time, collecting information from diverse sources, selectively aggregating and transforming them, restructuring and presenting them in a situated structure. Yet another challenge is to simultaneously maintain awareness of the diverse situations being maintained so that one user or process can leverage results being developed elsewhere.

While systems currently exist to perform each of these tasks, they do so inadequately, for the fundamental reason that no system currently integrates the functions.

There are current methods and systems for real-time aggregating of information from diverse sources and streams. These employ structural requirements to accommodate incoming streams and packets, structural requirements for sending messages to various components in the system, structural requirements for revealing meaningful insights to the analytical components in the system, and structural requirements for displaying information to users that conveys some or all of these other structures, based on the specific and temporal needs of the user as presented via interaction.

These methods and systems do not have the ability to formally structure the situation against which the restructured information will be filtered, transformed and assembled.

Somewhat unrelated to these structural systems are certain constraints imposed by the cognitive abilities of the human user. Humans reason in certain spatio-temporal ways, some of which are learned, and some of which are apparently due to inherent structure of the mind. An example of the former is the preference in certain societies with left-to-right writing systems to envision time flowing from left to right. The latter can be found in the way the mind seems to abstract relations in visual terms.

The mechanics behind these constraints are not fully understood, but their limits are well known. User interface designers try to accommodate these constraints in the design of user interfaces and information visualizations. However, these human cognitive strengths are rarely considered in the design of the information structures within the computing system. Significant improvement would result if the structures used by the computing system were informed by those apparently natural to the user.

Related to the design of such a computing system are emerging trends in representation technologies; these provide a greater range of options in how computing systems can structure and manage information internally. These insights result from modern advances in the mathematical foundations of logic, and include two-sorted logics where, for example, one logic reasons over context (that is, situations and attitudes) and another related but different logic reasons over facts in those contexts (as situations). An example of this is situation theory. These new logical techniques expand the internal vocabulary of what is possible to represent and reason about, but heretofore there has been no practical implementation of situation theory.

Finally, and somewhat unrelated are an expanded vocabulary of programming techniques. Functional programming has been known for some time, but its practicality has been limited. Functional code can be generated from mathematical structures, including mathematical structures that characterize logic.

Logical forms such as the two-sorted logic described above can be characterized by these mathematical structures. Using the Curry-Howard-Lambek correspondence, the mathematical structures can be mapped to programming code that is provably correct. Functional reactive programming now provides a more practical means for the application of the Curry-Howard-Lambek correspondence linking the logic of mathematics, specifically set theory, and programming code as reactive transformations of information.

Reactive functions are modules of functional code that are assembled in a persistent fashion so that changes in the input of any function trigger a “reaction” in others. Effectively, the notion of continuous functions is introduced in the code. The resulting benefit is that the mathematical characterization used in the math-to-code correspondence can support more powerful logics, such as the two-sorted logic of situation theory.

The previous state of the art has not combined these advances so that the following all coincide: matters concerning the cognitive display on the screen, the internal information structures of different kinds as described above, the programming code that addresses them, and the set theoretic mathematical characterizations. This is partly because the disciplines involved do not normally interact with one another.

Also it is the case that at the level required, the mathematics, the logic, and the programming techniques are relatively unused because by themselves each presents apparently insurmountable barriers to practical use. Among other reasons, it is difficult to design a system where the visual conventions and logic have mathematical rigor.

Accordingly, there exists a need to improve federated knowledge situating, representation, processing and display systems.

Moreover, there exists a need to have more powerful instances in each of the domains: graphical user interfaces, situated reasoning and effective knowledge federation to produce intuitive, situated structuring of information.

### SUMMARY OF THE INVENTION

The present invention presents a computer system for multi-situational knowledge federation, processing and display systems. In particular, the present invention provides a novel way to correspond multiple sets of information based on user context, and displaying appropriate transformations of those correspondences in a user interface.

### DESCRIPTION OF THE DRAWINGS

These and other embodiments are described by the following figures and detailed description.

FIG. 1 Illustrates the hardware architecture of the system.

FIG. 2 Illustrates the major information flow in the system.

FIG. 3 Illustrates the infon and situation structure.

FIG. 4 Illustrates the ontology graphs.

FIG. 5 Illustrates an example Cell.

FIG. 6 Illustrates components of Cell flow.

FIG. 7 Illustrates adding Points to a Cell.

FIG. 8 Illustrates removing Points from a Cell.

FIG. 9 Illustrates adding functions to a Cell

FIG. 10 Illustrates removing functions from a Cell.

FIG. 11 Illustrates the functional reactive fabric.

FIG. 12 Illustrates the reaction to user input.

FIG. 13 Illustrates lambda evaluation.

FIG. 14 Illustrates infon nesting.

FIG. 15 Illustrates tree computation.

FIG. 16 Illustrates a single field outline.

FIG. 17 Illustrates an Infon expander.

FIG. 18 Illustrates a Hilbert space visualization.

FIG. 19 Illustrates an ontology graph visualization.

FIG. 20 Illustrates typed intersituation links.

FIG. 21 Illustrates a display of a remote target.

FIG. 22 Illustrates a video and video scrubber.

FIG. 23 Illustrates situation cloud flows.

FIG. 24 Illustrates cloud details.

### DESCRIPTION OF THE PREFERRED EMBODIMENT

In the following detailed description, reference is made to the accompanying drawings, which form a part hereof and illustrate specific embodiments that may be practiced. In the drawings, like reference numerals describe substantially similar components throughout the several views. These embodiments are described in sufficient detail to enable those skilled in the art to practice them, and it is to be understood that structural and logical changes may be made. The sequence of steps is not limited to that set forth herein and may be changed or reordered, with the exception of steps necessarily occurring in a specified order.

Embodiments described herein are designed to be used with computer systems. The computer systems may include any computer system, for example, a personal computer, a minicomputer, a mainframe computer, or mobile devices. The computer system will typically include at least one processor, display, input device, random access memory (RAM), hard drive memory, communication device and possibly mass storage memory devices and subsystems, but may include more or fewer of these components. The processor can be directly connected to the display, or remotely over communication lines such as telephone lines, local area networks, or any other network for information transmission. The invention may be implemented with a variety of computing hardware. Embodiments may include both commercial off-the-shelf (COTS) configurations, and special purpose systems designed to work with the embodiments disclosed herein.

Embodiments may also be implemented with other hardware. For example, embodiments may be implemented using any of the following: field programmable gate arrays (e.g., field programmable gate arrays from the Altera Stratix® series, the Actel Fusion series, the XiLinx Virtex-5 series and the Tabula ABEX2-P™ series); graphics processing units (e.g., gaming and multimedia graphics cards such as Nvidia® GeForce® 8800 series, or ATI Radeon™ HD 4800 series); or multicore architectures (e.g., contemporary multi-core processors such as the AMD Phenom™ series or Intel® Core™ 2 series); tablets such as Apple's iPad™, iPhone™ or similar devices. Certain photonic computing architectures such as those enabled by nonlinear optics are capable of performing the tasks described herein. As long as the hardware (or other computer medium) and software used is capable of performing the tasks required by specific embodiments, the embodiments are within the scope of the invention, and include embodiments of hardware and hardware modifications that are not yet known so long as the hardware has the task performing functions necessary to carry out the invention described herein.

The present invention provides a novel computer system that synthesizes object programming, functional programing, data-flow programming, with advances in mathematical logic and cognitive modeling. The synthesis allows a system which closely aligns the manner in which a user interacts with a system, how that interaction is logically parsed, how set-theoretic composition of the logic results, how that set-theoretic algorithm builds functional reactive flows and how those situated results are structured for display to a user.

Such a system is reactive everywhere, adaptively and scalably supporting the reactive transformation of information as interpreted in situations. Disclosed embodiments provide for a distributed computer system using a client-server architecture. The disclosed embodiment applies paradigms from object (imperative) programming, functional programming, and data-flow programming. Using functional programming, which can specify code as mathematical functions and avoids state data, allows the system to perform incremental computing, to be dynamically reactive everywhere, and to provide self-contained information transformation, including situated interpretation.

Particularly, while the system and method of the present invention are described by the client-server architecture of the distributed computer system, the present invention can be implemented on other architectures, such as peer-to-peer or novel geometric topologies. Moreover, the present invention can be applied to other computing systems, and not only distributed computer systems. The system could even be practiced on a single computer.

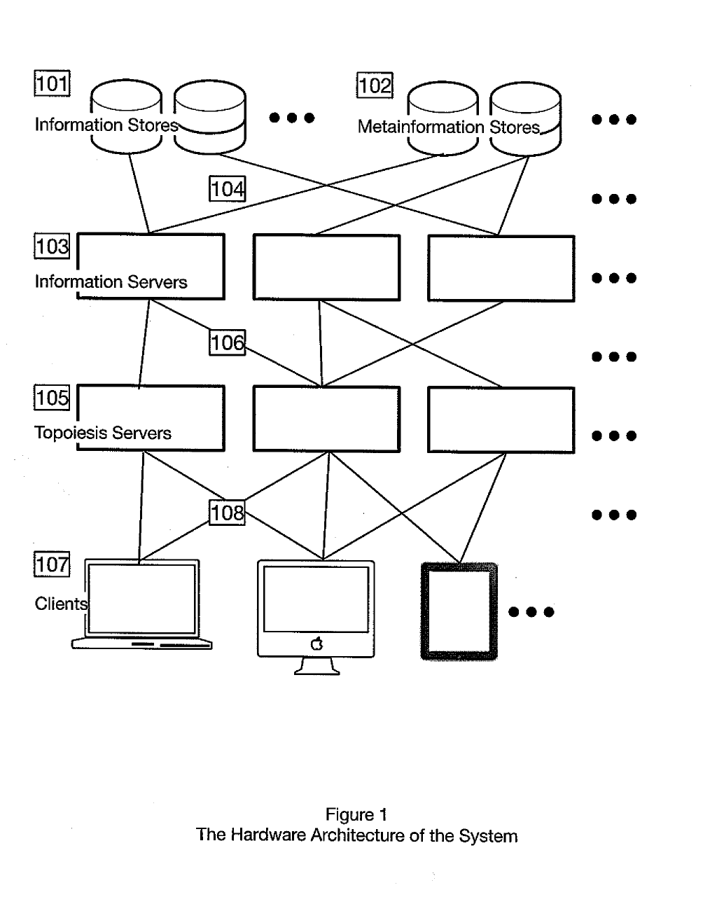

FIG. 1 is a first embodiment illustrating an integrated system including a middleware service that performs the reactive situating of facts. Information exists in a number of stores [101]. These may be conventional data, object or novel stores, or information streams supplying message, image or video feeds for example. The only requirement is that they be accessible to the system and desirable for some step of the functionality as herein described.

Some of this information has stored or streamed meta-information [102] that may be implicitly or explicitly associated. Examples of such meta-information may be ontology definitions, description logic, stored inferences, frame bounds, data dictionaries and knowledge compiler reports. The contents can be formal as required for interpretation or informal and optional.

Information Servers [103] perform the tasks of locating and retrieving information and meta information from these sources as directed by client-initiated activity. Any number of servers can be used based on locations and types of information and meta information. Any assignment of servers via dedicated or opportunistic connections [104] can be employed. The only requirement is that sufficiently correct information is served to the other components of the system as required. These Information Servers [103] can be conventional data, object or knowledge base servers or special purpose devices that take advantage of optimized queries.

It should be understood that Information Servers [103] manage information and meta information.

These Information Servers [103] can be discrete as illustrated or cloud-based so that there is no specific relationship between code and a device. The servers can adapt to support distributed loads, caches, security conformance and similar tasks.

The Information Servers [103] can also supply new information to be appropriately stored, as generated, inferred or otherwise supplied from the system.

The Information Servers [103] are connected to Topoiesis Servers [105] which perform reactive interpretation and situating of the information. Reactive interpretation is the process whereby a fact, set of facts or inference has its meaning affected by context of some kind. An example might be the simple phrase “Tommy boxed the bat.” If the context is wrapping Christmas gifts, then the phrase can mean placing sports equipment in a container. If the context is spelunking, then it is likely fending off a flying mammal. The need to interpret and reason in context is essential and basic. The Topoiesis Servers [105] build reactive functions based on information from Clients [107] and the Information Servers [103] to manage situations and interpreted facts as required. This is accomplished as described below.

The Topoiesis Servers [105] are connected to the Information Servers [103] via links [106] that convey information and meta information in two ways. These can be dedicated persistent links, opportunistic short-lived links or some combination as required by the hosting and topology of the system. Links [104] and [106] can be across networks, including internets, Internet and intranets, or by connections internal to devices or virtual devices.

While it is not required that Information Servers [103] use functional, reactive or functional reactive methods, it may substantially improve the accuracy, access of information and the collection of associated meta information. This is because for information to be interpreted, some collection of meta information often has to be retrieved and evaluated. If for example, we had information about ‘a bat’ then some ontological meta information will have to be retrieved. If the context can be constrained to sporting equipment, the amount retrieved and the evaluation performed can be greatly reduced.

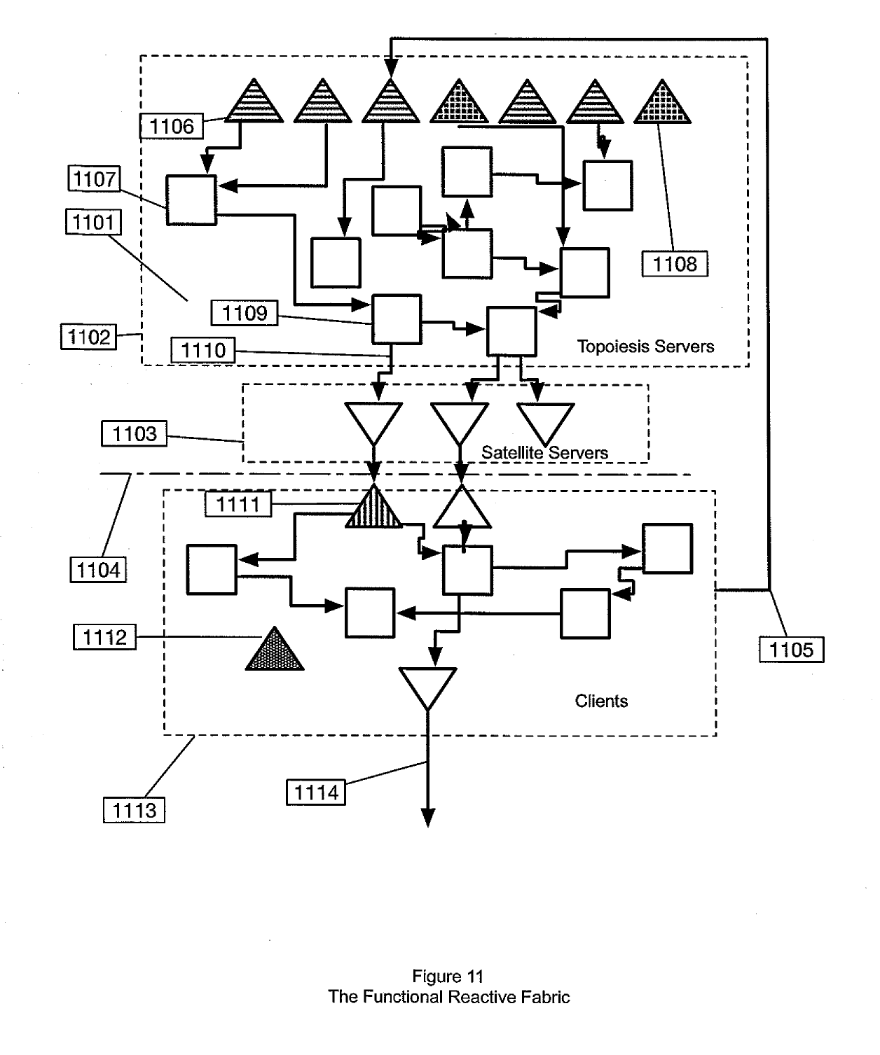

Topoiesis Servers [105] are connected to Clients [107] via connections [108]. Connections [108] are determined and managed by shared code in the Clients [107] and Topoiesis Servers [105] as described below in FIG. 11.

(Previous descriptions of the code shared between Topoiesis Servers and Clients named it a ‘kernel’ following the common practice in the artificial intelligence community. This also conforms to the use in certain products, for instance Wolfram Mathematica™ which has code shared between and mobile among client and server. The term is used in U.S. application Ser. No. 12/798,487.

However, readers may confuse the term with its wider use as the core of an operating system. We therefore avoid the term here. The “kernel” in previous descriptions is the code in the Topoiesis Servers [105] other than the specific code that manages the connections [104] plus the code in the Clients [107] other than the code that manages the user interface display. In the present disclosure, we use the term ‘shared code.’ FIGS. 1 and 11 further illustrates this.)

Clients may or may not be associated with human users.

The system functions by Clients [107] accessing information using common methods to access, fuse, evaluate, edit and create information, performing transforms and reasoning. Additionally, each Client [107] has several default situations associated with it. For example, the day, the user, the intended task and past history. In a preferred embodiment, the system will learn from the client's past actions and create additional situations to act as an intelligent assistant.

Moreover, information comes with default or assumed situations as basic and alternative interpretive meta information. Additionally, a sophisticated user will want to include other situations, implicitly or explicitly.

Examples of this that are illustrative but not complete, include: an intelligence analyst trying to understand some belief not objectively true but what is believed to be true in (the situation of) the mind of someone else; a reader of a story who is trying to understand the situation of what has happened and what might happen; a designer of a manufacturing enterprise with fluid partners who needs to merge the situation of a partially designed product with the situations of processes among partners who can manufacture it; a pharmaceutical research biologist working simultaneously at the level of protein interaction and neural regenerative systems and who wishes to understand the Situation Dynamics of the connection.

(Detailed examples of needs for situated analyses can be found in:
Goranson, H. T. (1999). The Agile Virtual Enterprise: Cases, Metrics, Tools. Greenwood International.
Goranson, H. T., Cardier, B. (2007). Scheherazade's Will: Quantum Narrative Agency. Proceedings from AAAI Spring Series Workshop on Quantum Interaction, Stanford, Calif.
Cardier, B., Goranson, H. T. (2009). Storymaking across contexts: how a fiction writer and a team of computer scientists came to terms. Kunapipi: Focus on Science 31, 37e51.
Cardier, B., (2012). Unputdownable: How the Agencies of Compelling Story Assembly can be Modelled Using Formalisable Methods From Knowledge Representation, and in a Fictional Tale About Seduction. University of Melbourne.
Goranson, H. T., Cardier, B. (2013). A two-sorted logic for structurally modeling systems, Progress in Biophysics and Molecular Biology, http://dx.doi.org/10.1016/j.pbiomolbio.2013.03.015

The latter two of these are wholly included in the provisional filing 61/732,326 of 1 Dec. 2012.)

Therefore, the Clients [107] will use the system as a whole and in particular the Shared Code to display as required these situations and the effects they have on the information in question. The system is reactive, so that if any situation changes or the presumed interpretation of a fact is enhanced, then the entire system adjusts and the Client [107] can view the effects in real time.

An illustrative but not limiting example of such a need for reactive response is in collaborative analysis, perhaps for medical research or business intelligence. An example is when one analyst is able in some way to improve the understanding of a key fact, and that fact (or some downstream inference) is relevant to another analyst. In such a case, the situation of the first analyst becomes a governing influence over other relevant situations. This will be conveyed to the second analyst, and the implications for work in progress will be reported. Many examples of this need exist.

FIG. 1 indicates that there can be any number of each specified object [101], [102], [103], [105] and [107]. The figure further indicates that connections [104], [106], [108] between pairs of these objects as shown can be arbitrarily many and connect to and from any pair of the respective objects. The lines in the figure are notional.

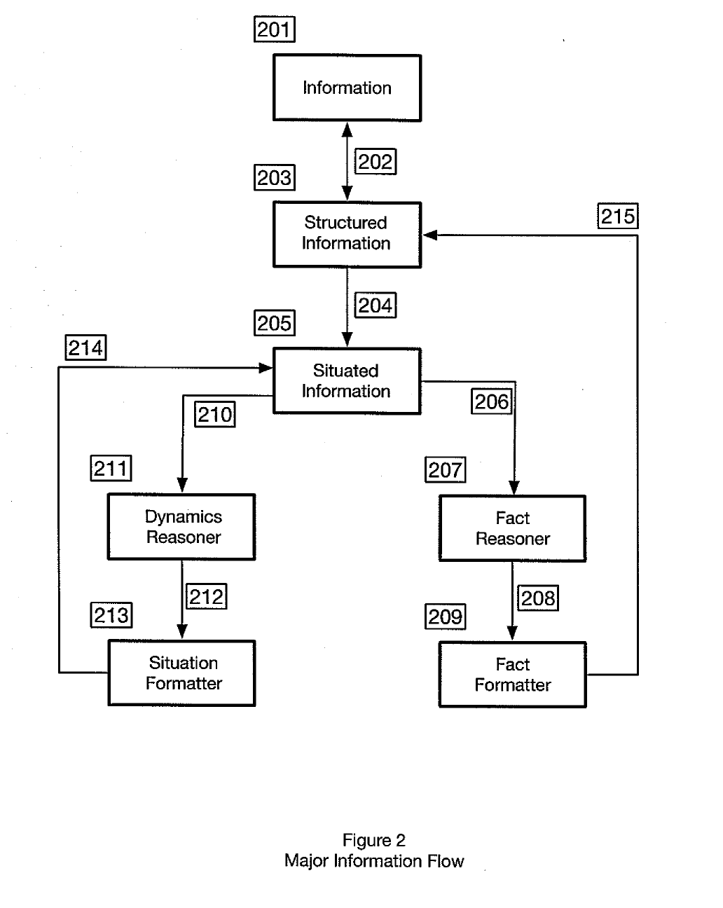

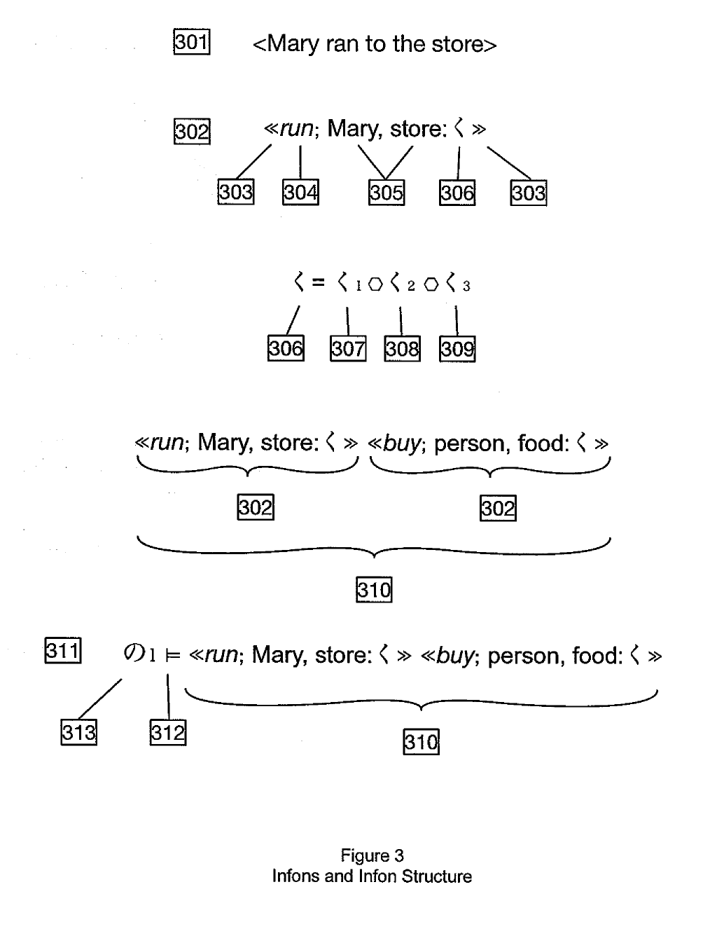

FIG. 2 illustrates the major information flow through the system as states. Information [201] enters the system. In state [202] the information is structured to be computable by states in the system further on. The required structure is Topoiesis Infons, described below. Supposing that incoming information is in the form of Resource Description Framework (RDF) triples, the restructuring is a simple transposition. RDF triples specify subject-predicate-object expressions. Infons are displayed as predicate; subject, object expressions (See FIG. 3), so mapping from RDF to infons is economically feasible. Such mapping allows us to take advantage of the OWL Description Logic (as RDF Schema) (W3C, 2009), which is currently the most mature ontological framework. This is just an example; any sufficiently formal ontological framework can be used.

State [203] may require human intervention, if the source information is not sufficiently well structured to be formed into infons by algorithm or adaptive expert systems.

State [205] assembles the infons into expressions based on “situatedness” [214]. These are a collection of situations calculated to be potentially relevant based on actions by the user and stored history. Histories of past relevant situations or situation patterns are stored as facts in the persistent store via the pathway [215], [203], [202], [201]. Each of the situations considered potentially relevant are designated the left hand side of a situation theoretic equation, and the associated facts are on the right hand side of such equations. The form of these equations is novel and an enabler of the invention.

The result [206] from this structuring process is a collection of facts or inferences that are explicitly linked to their qualifying contexts. In parallel [210], manages a collection of situations with the structures from the relevant right hand sides as a defining quality. The form of these expressions is also novel and an enabler of the invention.

On the right hand side of FIG. 2, state [207] performs whatever transformative steps the user requires. The reasoning system in state [207] can be any system in use, or any future system that makes inferences over facts or which transforms information algorithmically. It is a feature of the system that it can accommodate any existing reasoning framework. Note that state [207] is located after [205] ensuring that the facts are semantically nuanced correctly, because of their situatedness, and that the inferences are correct.

This is a significant advantage of the system. Many incorrect inferences are promulgated through current reasoning systems because the facts, the logical connectives and the fact structures that result have not been adequately situated. For example, if the system misunderstood the meaning of ‘bat’ as previously described, it would promulgate an error through an entire reasoning chain.

States [207] and [209] are separate to ease the integration of an existing reasoning system from elsewhere. As noted, the Fact Reasoner [207] need not be a ‘reasoning system’ in the advanced sense. Any task capable of being performed on a von Neumann/Turing Machine can be hosted here. The minimum effect of integrating the described system to a legacy reasoner is that facts and inferences that the reasoner sees will be more correct. Possibly, the number of computations will be vastly fewer, because relating facts to situations has the effect of constraining them. The result is that in some cases, fewer facts or fewer inferences will have to be evaluated.

Supposing that state [207] is implemented using functional code that is integrated with the Situater of state [205], then lazy evaluation techniques can be employed. Lazy evaluation in many contexts can greatly reduce processing complexity. A benefit is enhanced system speed.

An additional potential benefit in state [207] over similar but unsituated systems is that whatever logic is employed in state [207] can now be employed to reason about situations as if they were facts. For example, if you were reasoning about what a story means, the implicit situations are what is in the interpreter's mind and what is in the world of the story. But suppose that your interpretation would be enhanced by reasoning about what is going on in the mind of a central character.

That situation of the character's mind can appear in state [207] as a token to be carried in the logic as an unevaluated fact. It is not a fact per se because facts can be fully evaluated where situations usually cannot. (You cannot fully know what is going on in someone's mind, for example.) But you can now reason about the situation in such a way that you can use what you know, use what you assume (but have it be clearly tentative) and be conscious of what you do not know.

The Fact Formatter [209] performs the task of translating the elements of state [207] to elements that can be directly used by the user interface. Because the system understands situations and the relationships of facts, inferences and situations, all of these can be displayed by capable user interfaces. User interface designers can take advantage of unique strengths of the overall system if they are suitably exposed. Therefore, the system must format information in a way that can support such advanced interfaces. The Fact Formatter [209] performs this task for the facts, while the sibling Situation Formatter [213] performs this task for the situations.

The formats used depend on the nature of the interface employed. Additionally, the Fact Formatter [209] will necessarily be coded differently for each edition of the Fact Reasoner [207] employed. As noted, any pre-existing method can be accommodated by the Fact Reasoner [207], and in some cases existing code of legacy reasoners can be inserted.

The Fact Formatter supports an additional task; certain reasoning operations in the Fact Reasoner [207] will create new or affect existing known situations in the system. Also, most operations in the Fact Reasoner [207] step will resituate information throughout the system. Therefore, the format created by this step can deliver information appropriate for a novel user interface, with the same format appropriate for ingestion into the Structured Information [205] step via [215] where adjustments are made to all the fact-to-fact, fact-to-situation and situation-to-situation relationships through the system. Any persistent change is further conveyed back via [202] for storage or modification of stored or streaming information.

While the flow on the right hand side of FIG. 2 illustrates the handling of situated facts, the states in the flow on the left hand side illustrate those associated with situations. A difference is that the reasoning over situations as disclosed below is unique to the invention. State [207] can accommodate any ordered logical or algorithmic processes. The Dynamics Reasoner [211] in contrast must use the categorical operations of the system. These are domain specific and will vary from implementation to implementation depending in part on a balance between depth of insight opposed to computational efficiency.

For example, in the domain of general intelligence analysis, the situations may best be modeled using 2-categories. In the biomedical modeling field, the category types used for situation modeling could instead be skeletal lattices, and the functors that model the Situation Dynamics can be morphisms. In the described embodiment, the categories belong to the category of sets.

Another difference between the left and right sides of the figure is that the state of facts and inferences is fed back into the flow earlier on the left hand side. This is because the only explicit information that can exist in any system are facts. (In this context, any information is a fact.) Some qualities of situations can be expressed as facts. An example is the fact that a situation exists (or can exist). Another example is the fact that a certain situation supports a certain string of facts with connectives. (In this context, any operator is a connective). These facts can be stored, structured, situated and reasoned over like any other fact.

As a result of this asymmetry between left and right hand sides, situation state changes are fed back into state [205], where situations, facts and logic are properly registered with each other. This occurs via [214].

It should be noted that FIG. 1 depicts only one architecture that can support the flows in FIG. 2. The relationships between FIGS. 1 and 2 are:
Information Stores [101] and Information Servers [103] support state [201] in the Information Flow.
The Information Servers [103] and Topoiesis Servers [105] support states [203] and [205] but not necessarily serially. The system's functional reactive code is highly recursive so it is possible that a combination of states [203] and [205] are performed by some collaboration among the servers [101] and [103].
Either the Topoiesis Servers [105], the Clients [107] or some collaborative mix can support states [207] and [209] on the right hand side and the corresponding states [211] and [213] on the left hand side, together with the upstream loops [214] and [215]. As a matter of implementation, the system has portable code that can be moved (or turned on/off) between Topoiesis Servers [105] and Clients [107]. This mobility is described below in connection with FIG. 11.

Such code mobility may be desirable for instance in the case where Topoiesis Servers [105] are few, large and centralized, the Clients [107] are very many and small computing devices, the Topoiesis Servers [105] and Clients [107] are connected [108] via the Internet and the system wants to balance the processing load by dynamically moving processes among instances of [105] and [107]. (In previous disclosures, this was described as a ‘kernel.’)

Note that it is possible for an existing reasoning system to be used at state [207], possibly with direct use of legacy code. Not shown in FIG. 2 is the ability to have a legacy system have a legacy user interface integrated into the flow at state [207].

Also, complex implementations of this system will require that an expert in Situation Dynamics populate and refine the dynamic principles. It may be useful to have a specialized user interface for this task. Typically, such an interface is related to state [211] rather than requiring the Formatter [213] for situation and fact display. (Situation Dynamics are the rules by which the “second sort” of logic works. This is the reasoning system on the left hand side of situation theoretic equations as supported by state [211].)

FIG. 3 illustrates the infon and situation structure.

The embodiment's normalized fact is in the form of an infon. This reflects the influence of Situation Theory. A reference on situation theory is “Situations and Attitudes” by Jon Barwise and Jon Perry, MIT Press, 1983. Subsequently, Keith Devlin devised the infon for use in situation theory. See “Logic and Information” Cambridge University Press, 1995. We restructured and extended the concept for use in this system. A full reference of this work (included in filing 61/732,326) is: “A Two-sorted Logic for Structurally Modeling Systems” in Progress in Biophysics and Molecular Biology 864, 2013 (doi:10.1016/j.pbiomolbio.2013.03.015). Our infons are called “Topoiesis Infons.”

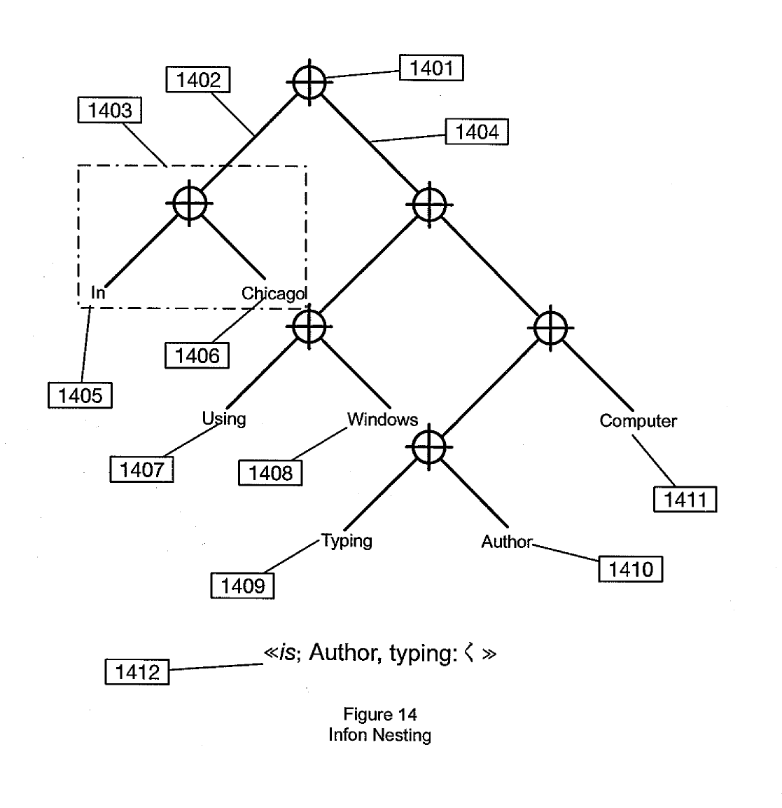

An infon is a standard representation of a fact. Any chunk of information, information element or logical statement can be expressed in infon form. We convert to Topoiesis Infon form to normalize information across the system. Code operates on information, changing its internal structure and changing their interpretation, so we require that all information in the system be of a normal form. Many forms can be used. The embodiment described here uses Topoiesis Infons but any suitable normal form can be employed. FIG. 3 shows an infon in informal notation [301]: denoted by single chevrons enclosing a natural language expression. The formal notation [302] consists of the following elements:
enclosing double carets [303]
a defining relation [304]. The relation is between two parameters. Both relations and parameters are ontologically defined, meaning that for each element, the system has ready, persistent access to an ontological graph of logical statements that define each term encountered to some axiomatic primitives. We use sanserif fonts for the relation and its two parameters. The relation appears first in italics.
the two parameters [305]. The position of the parameters is significant. We prefer (but do not require) relations that operate from one parameter to another. Possibly they transform or nest the interpretation of parameters as described below in connection with FIG. 14. In the case of a natural language statement, the first parameter is the subject of a statement and the second is the object. For example, the statement “Mary ran to the store” would have the relation “run” [304], the first parameter [305] as the proper noun “Mary” and the second parameter [305] as “store.” The relation “run” is tenseless because its placement in time is part of the placement in situation.
an interpretive function denoted by the Japanese character “Ku” [306]. This function is assembled on the fly based on a secession of functions that capture situation dynamics. This is described below.

All Topoiesis Infons are binary, having only two parameters. Any complex fact with more than two arguments can be perfectly resolved to at least one collection of binary infons. Any suitable syntax for Topoiesis Infons can be used; the example is only one suitable syntax. Decomposition rules are described below in connection with FIG. 14.

The Ku operator has three components, denoted by suffices 1, 2 and 3. The combination of Ku operations described are not prescriptive. Many other decompositions are possible depending on the implementation domain, the categories selected and the engineering of the situation dynamics. In this embodiment, the first of these [307] reinterprets the Topoiesis Infon based on what Topoiesis Infons have come before in an Topoiesis Infon stream that influences the present Topoiesis Infon. If, for instance, previous Topoiesis Infons infer that the context is sport and gifts, then this first component [307] shifts the ontology to favor the interpretation for “Tommy boxed the bat” toward a baseball bat in a gift container.

In the present embodiment, the second component [308] of the Ku function similarly reinterprets the Topoiesis Infon, but this time based on the Topoiesis Infons that appear later. For example, it may be revealed that the previous sports gift context does not apply (perhaps it was a dream), and Tommy is now endangered in a cave. This phenomenon is common, and is explored in detail in “Unputdownable: How the Agencies of Compelling Story Assembly Can Be Modelled Using Formalisable Methods From Knowledge Representation, and in a Fictional Tale About Seduction.” Phd. University of Melbourne, Melbourne, Australia, 2012. This document is also wholly included (in draft form) in filing 61/732,326)

In this case, the interpreter retroactively reinterprets the Topoiesis Infon. Perhaps in the interim, a great many Topoiesis Infons after this one will have been interpreted via the first component of the Ku function, based on the initial interpretation. Therefore, the second component of Ku will trigger perhaps a series of reapplications of the first component, some of which in turn will recursively trigger applications of the second component.

The third component of Ku [309] in this embodiment comes directly from the situation dynamics to be described below, and associated with state [211] of FIG. 2. It similarly affects the interpretation of the Topoiesis Infon. Some dynamics may include multiple contexts that all apply, with one governing. This is often the case with deliberate ambiguity, metaphor, poetry, irony and sarcasm—all being phenomena that are widely found.

Topoiesis Infons typically can be generated by two methods. One leverages natural language parsing techniques to map concepts to infons. This is as shown in FIG. 3, producing a structure that is human readable. Not all infons will be easily understood by a human reader. A preferred embodiment will use a type system and translation methodology to maximize this readability so that even though the notation is formal, the tokens can be human-interpreted.

A second method of generating Topoiesis Infons is the interpolation of Resource Description Framework triples. This sometimes requires extensive preparation because the typical formation of an RDF triple assumes a closed world and a static interpretation. We allow open worlds, the open set of ontological possibilities and a dynamic semantics. So for example, information about tense needs to be split out if it appears in an RDF triple and assigned to a new triple that basically records the situation of placement time associated with the source RDF.

This method of Topoiesis Infon generation can leverage the substantial number of tools, existing ontologies and studies on description languages coming from the Semantic Web community. Translating information of many kinds into RDF triples is known practice in the art and supported by many tools.

Users can manually create Topoiesis Infons as well, and this is supposed in the case where a user employs a compatible user interface. The user can enter a new or derived fact, even one that references a situation, and have it be related in the maintained Functional Reactive Fabric of facts.

A feature of the invention is that an embodiment may be coded using Topoiesis Infons. In this case, the relations [304] of Topoiesis Infons representing code are functions in the programming sense and the parameters are parameters of the function, either two operands, or a source and target. In this way, the system can be fully reflexive and modify itself based on the architecture described in FIGS. 1 and 2.

Topoiesis Infons can represent facts, collections of facts and inferences or results of transformative processes. A Topoiesis Infon can also hold a token for a situation. When browsed by human or automated process, they can be expanded to their constituent infons and then, as earlier described, the ontological graphs can be traced. Therefore, each element in a Topoiesis Infon represents a terminal node in a possibly very large ontological graph structure. A core novelty of the invention is that it dynamically maintains the links that construct this graph.

In conventional notation of logic, an inference or predicate expression may consist of facts connected by logical connectives. For example in the expression: “<all men are liars> AND <Tom is a man> THEREFORE <Tom is a liar>”, “AND” and “THEREFORE” are logical connectives. We can support a very broad class of connective types sufficient to cover any encountered situation, real or fictional. These connectives are subsumed in our Ku function.

The described embodiment constrains the logical connectives in two ways. They must define a linear logic, and that logic must be intuitionistic. The first constraint requires non-commutative connectives. The result is that the order of the facts in the expression matters. The facts you know (and have tentatively interpreted) constitute one of the salient situations that bear on the appearance of a new fact.

The requirement for an intuitionistic logic is satisfied automatically from linearizing the logic, in most practical implementations of linear logics. Both of these forms of logic have been well understood for decades and are well known in the art. Just as it is possible to map any structured information into Topoiesis Infons, so too it is possible to map any set of codable operations into a linear, intuitionistic system by means known in the art.

FIG. 3 shows a statement [310] consisting of two Topoiesis Infons [302]. In this case, the reader can assume the connective is of an “and-then” type. In the case of the second Topoiesis Infon being placed in the same statement and after the one that preceded it, the identity of “person” will be weighted toward “Mary.” The figure shows only two Topoiesis Infons but the expressions can be arbitrarily long. Also, the figure shows a strictly linear appearance, but complex branch structures and networks can be supported. These can be graphically displayed to show parallel non-dependent expressions or presented linearly with “while” type connectives.

FIG. 3 further shows a full situated statement [311], It consists of a right hand side comprising a combination of connected Topoiesis Infons. The two other elements are a ‘turnstile’ relation [312] which discriminates between right and left hand sides, and a token [313] denoting a situation. (As with the Ku function, we use Japanese (hiragana) kana characters to denote types of situations.)

This statement can be read alternatively: “the situation on the left hand side is supported by (or partially defined by) the structured facts on the right;” or “the structured facts on the right are interpreted within the situation on the left.”

These situated statements [311] form the basis of the two-sorted reasoning system. The two “sorts” are systems of reasoning for the two sides of the equation.

The relationship between FIG. 3 and FIG. 2 is as follows.
Structured information is available to the system at state [201]. This may be raw information from sensors or information that has been preprocessed for expedited use in the system. In other words, the information may not be structured as Topoiesis Infons.
Information is structured at state [203] to be in Topoiesis Infon form [302], and Topoiesis Infon expressions [310]. State [203] constitutes a working memory for the system as a whole and may have some persistent information store to hold often accessed information. Information at state [203] consists wholly of Topoiesis Infon [302], expressions [310] and their associated Ontology Graphs. Also, as previously noted the existence of a situation as a fact is stored here as well in a Topoiesis Infon. Other “hard information” about situations can be stored as well.

Our reference to Topoiesis Infons includes these hard facts as well as combined expressions [310] and [311].
State [205] is concerned with creating situated statements [311], using stored Topoiesis Infons that inform situations, further information from reasoning at states [211] and [207] and enhanced insights provided by users and automated analysts. At state [205] a great many situated statements are typical. Many Topoiesis Infons and assemblies will appear in different situations. At state [205], every element of every fact now exists in a structured environment where the detailed interpretation of any element or assembly can be traced to primitives via the associated ontology graph.

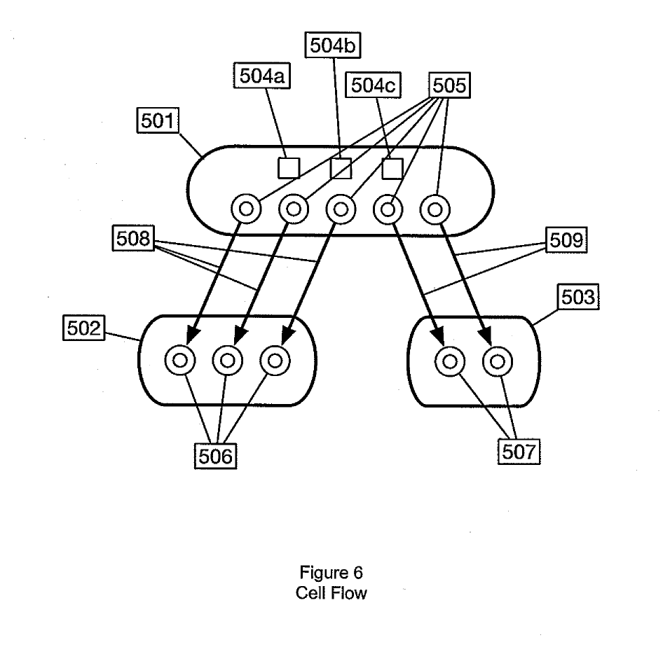

(States [211] and [213] are described later in association with FIGS. 6 through 11.)
State [207] executes and manages the linear intuitionistic logic that is instanced in the system. Note that details of this logic could emerge from reflexive learning, supposing that the system code is stored in appropriate Topoiesis Infon form. Note also that any existing reasoning system may be subsumed in this state [207].
State [209] maps Topoiesis Infons, infon expressions and Ontology Graphs, including those that capture qualities of situations to user interface objects.

Many operations so far described use techniques known in the art. State [203] can be implemented using techniques from the Semantic Web RDF community. State [205] is a matter of reformatting infons such that infons that capture info-situation relationships have the situations mapped to left hand side objects. This can be accomplished by a number of term rewriting systems.

State [207] may consist of two types of modules using techniques known in the art. One module supports the actual reasoning of the linear intuitionistic logic specified by the domain. The other module type is optional and maps legacy logical reasoners of other information processing systems to the linear intuitionistic logic by real time mapping. Multiple instances of this type can be supported if the use requires integration with a number of legacy analytical systems.

Now we turn to the left hand side and a description of the two states [211] and [213] and the relationship with state [205].

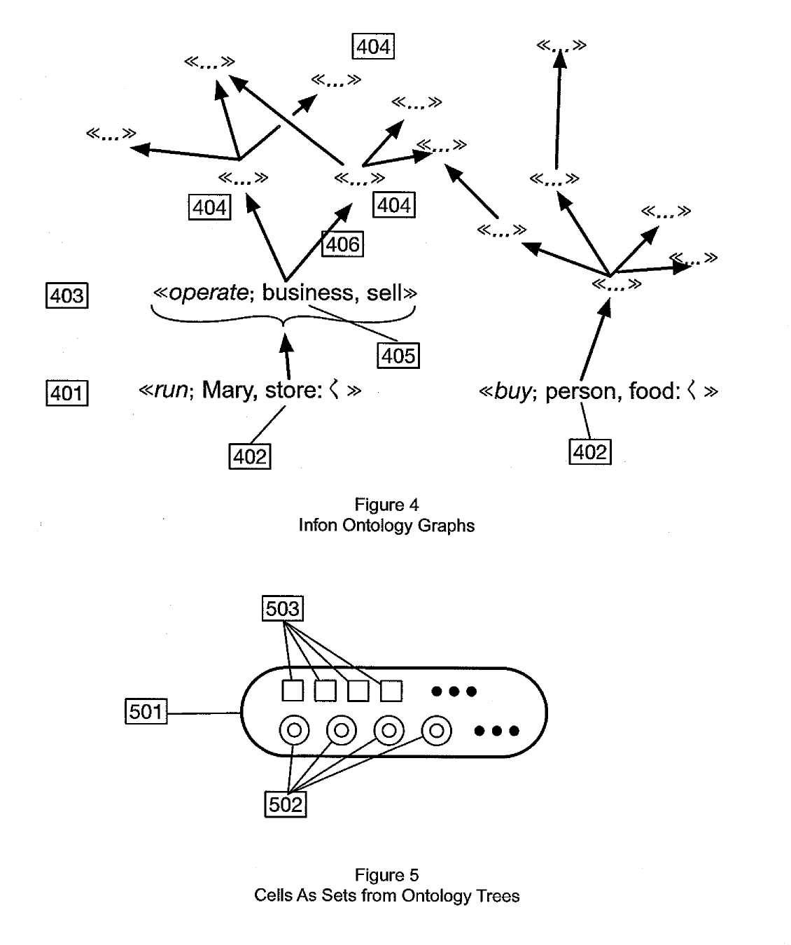

FIG. 4 illustrates a Topoiesis Infon [401]. (Topoiesis Infons [401] of FIG. 4 are identical to Topoiesis infons [302] of FIG. 3.) The figure schematically shows part of an Ontology Graph assigned to one of the parameters. When the core Topoiesis Infon [401] reaches state [203] of FIG. 2, it will have the associated structure of its entire associated ontology graph. For example the parameter “store” may appear with the anchor of its Ontology Graph as “a business whose function is sell.” This is illustrated in the example Ontology Infon [403]. Note that Ontology Infons in this example do not have an associated ku function of Topoiesis Infons because they are not a direct constituent of the information being examined.

An embodiment is possible that linearizes the Ontology Graphs and captures the ontology relations, here shown as Arrows, as ku functions. In this case, Ontology Infons will be identical to Topoiesis Infons. This allows for computational efficiencies once in the system, but slows the structuring process shown as state [202] in FIG. 2. The described embodiment assumes the use of RDF, structured tools and ontologies, so Ontology Infons are stored as shown, where each of the three internal components has a definitional expansion as other Ontology Infons.

These expansions continue either until they exhaust the ontology by ending at axiomatic primitives, by terminating at a detected circularity of by reaching a user-defined depth of definition. This definitional depth can be determined arithmetically by the number or depth of Arrows [406], the number of nodes in the expanded three or graph, or some compound evaluation that may employ ontological metainformation not shown in the Figure. The resulting structure is the Ontology Graph for a given Topoiesis Infon.

Such Ontology Graphs can be quite large. As situated influences change, these graphs can modify in profound ways.

The system manages these influences and the modifications of the Ontology Graphs by abstracting sets from the Ontology Graphs. Each Topoiesis Infon [401] generates a set. The set consists of two types of elements: Points and functions. Points are the parameters from Topoiesis [402] and Ontology [405] Infons. Functions are the relations from each type of Infon. Ontology relations shown as Arrows [406] are limited to definitions defined in the description logic used in the Ontology Graph. A simple example is the “is-a” relation, for instance a “store” in the Ontology Graph of FIG. 4 “is-a business whose function is sell.”

Functions and Points are serialized as independent subsets. A method for building and ordering these sets takes advantage of the structure of Topoiesis and Ontology Infons, collecting all the sequence beginning with first parameters of the Topoiesis Infon and continuing to the first parameter of the connected Ontology Infon, continuing until the end of that branch of the Ontology Graph. Then back down the graph to the previous Ontology Infon and follow the function sequence again on the left until the graph is exhausted.

The result is a set for each Topoiesis Infon. This is schematically shown in FIG. 5 as a ‘Cell.’ Each Cell contains a number of Points [502] and a number of functions [503].

Because they are constructed by logical means from a logical order, these are “pure sets” of the kind that define a “von Neumann universe.” As a consequence, they are amenable to formal manipulations. We have devised a formal manipulation that treats the Cells as objects which can be efficiently managed by object-oriented programming methods and frameworks. Examples are Java™, Objective-C™, Python™ or Scala™ which would be capable of the operations described herein. An implementation exists using Erlang™, which has the advantage of robust concurrency and the support of mobile objects as described in connection with FIG. 11.

A set-theoretic algebra among these Cells, implemented in simple code known in the art, is described in the next few figures.

FIG. 6 illustrates the Cells generated as part of the operation in state [203] and delivered to state [205] where the Functional Reactive Fabric is constructed and through which the information flows as it is interpreted for state [207].

As described above, functions can be stored or cached locally for reuse at state [203]. They can also be stored for global reuse in stores [101] and [102] where they can receive unsolicited, opportunistic updates.

Cells work to collect component functions in order to create aggregated functions that are implemented as reactive functions in a Functional Reactive Fabric. These aggregated reactive functions situate the interpretation of every Topoiesis and Ontology Infon in the system. In other words, there is a two-step computation at state [205]. One step builds Cells by the method we have described, namely graph tracing. The second step uses the reactive functions and their arrangement in a Functional Reactive Fabric, extracted from the Cells to dynamically color the interpretation of each Topoiesis Infon by rearranging and reprioritizing the Ontology Graphs.

This is a highly recursive process, because the Functional Reactive Fabric is changing the Ontology Graphs used to generate the Cells which in turn are used to create the Functional Reactive Fabric. Any change by any component in the system adjusts the Functional Reactive Fabric. These changes will include new or modified Situation Dynamics as performed in state [211] or as manually entered via a user interface associated with state [213].

An example use might be in an intelligence setting, for example as an analytical workstation for a defense analyst. Such an analyst may be the recipient of a large amount of streaming information, some raw from sensors and some provisionally annotated by collaborators. The analyst will have her own Clients [107], including those reasoning as performed in state [207]. The analyst will be interested in processing, filtering and composing the information in different contexts so that patterns can be discerned, inferences can be made and reports generated. The Functional Reactive Fabric of [205] has two novel properties:
It is reactive so far as the incoming information. As new information comes in, the “pipelines” of the Functional Reactive Fabric process it continuously so that the user interfaces associated with [207] and [209] reflect reinterpretation in real time.
A second way the Functional Reactive Fabric is novel is that it is reactive so far as the functions and functional composition. New information of various types can change the functions or their composition in real time.

This new information and new interpretation can come from the user directly, as change from reasoning in state [207] or [211], or by change precipitated by new source information. For example, a remote analyst can identify an object on a video that has been streamed to the user via state [209] through the Functional Reactive Fabric of state [205]. The user will have already drawn conclusions based on prior knowledge of that section of the video. But with this new information the Functional Reactive Fabric changes all of the inferences, interpretations and display accordingly. This can be a very large and complex set of inferences and transforms.

A different kind of change may come from a remote analyst or service that modifies the Situation Dynamics instead of an instance of information. For example, a Situation Dynamics expert or automated situation reasoner may supply a new or improved situation dynamic at state [211]. This may in turn modify any of the functions or the way the functions are assembled into the Functional Reactive Fabric [205].

Yet a third type of dynamic change in the system may come from a desire to evaluate the information in a different context. In this case, a different collection of information or a distinct different situation might be selected via a compound user interface associated with both [209] and [213]. This could be a shift “into” a situation that is already defined, for example: “Let me see these facts the way this character does.” Alternatively, it could be a wholly new situation or one synthesized from known and new situations. The new situation this becomes a governing situation. This information is delivered via [214] as a new function, rebalancing the relative importance of ontological links and modifying some links. The Function Reactive Fabric is thus changed.

For example, the analyst may wish to analyze the information the way a religious fundamentalist would, in order to understand motives, intents and make predictions. Or she may choose to perform a different sort of analysis. An example in this case might involve a shift from analyzing the near term manufacturing and technical capability of a country to looking at long term agricultural and epidemiological perspectives. Making this shift requires changing the Ontology Graphs.

The analyst may further choose to evaluate the information in many contexts simultaneously and establish a higher level analytical context to understand the differences and intents. Path [214] is the feedback connection from such a user. Changes in one area can affect modifications in another. For example, new analytical methods supplied or discovered and stored, may modify basic knowledge of the world used in constructing the Cells [501] of FIG. 5. FIG. 6 illustrates the Cells and their constituent elements. Cells [601], [602] and [603] are the fundamental units used in mapping from Ontology Graphs to the Functional reactive Fabric that situates and recursively modifies Ontology Graphs.

Cells map to sets, and the underlying mathematics that informs this module is set-theoretic; among other things, this allows for a functional programming paradigm to exist concurrently with object programming. Generally, there is one Cell [602], [603] per Leaf of reactive Function [1106], 1108] and [1111], as shown in FIG. 11. Cells comprise Points [605], [606] and [607] which represent incoming information from state [203] of FIG. 2. Cells also are comprised of functions [604], which can be performed on the Points [605], [606] and [607]. Arrows [608] and [609] emanating from Points [605] to Points [606] and [607] represent computational history as signals.

Cells, Points, and Arrows are created by and exist in both Topoiesis Server [105] and Client [107] hardware of FIG. 1. For example, a [601], [602] or [603] can be created by a signal from a Client [107] workstation computer, or by any one of the servers within the server cloud. Cells (and the Leaves and transforms of information they build), are stored in memory associated with state [205]. In another example, information provided to a Topoiesis Server [105] can be transformed by that processor into Points, or Points can be created by signals from Client [107] computers in response to transforms of information. Points are transformed by processing elements, and the resultant Points are stored in memory. Furthermore, Arrows can also be created by Topoiesis Servers [105] or Clients [107]. Arrows [608] and [609] are dependency records which are represented by signals which may be manipulated to emanate to and from particular Points. As it is known in the art, signals and their results may also be stored in memory.

Points [605], [606] and [607] represent information. Cells in the top-most Leaves [1106] of FIG. 11 in the system contain base information to be manipulated. Information may be objects or streams, but may also be functions, facilitating the function programming paradigm. Points may exist in Cells. Functions [604] may also create Points [606] and [607]. Functions are only performed on Points within in the same Cell as the function. Functions, among other things, manipulate and transform information. All resultant Points from performing a function are located in a single Cell.

For example, in Cell [601], if a Function [604c] is performed as the result of a first signal, it is performed on all Points [605] within that Cell. Performance of that function results in the creation of a new Cell [603], as well as resultant Points [607] which will populate the new Cell [603]. Points [606] and [607] are resultant Points created by functions [604b] and [604c], respectively. Function [604a] has been performed on all Points in [605], however, there may be no resultant Points and a new Cell (not shown) is created, but remains empty. A second signal may trigger another Function [604b] changing the resulting arrangement.

Performing the operation, creating the new Cell, and creating the new Points, results in the creation of Arrows [608] and [609]. Arrows are a dependency record between Points as well as between Cells and capture the computational history (and the following computations) of information in the system. In the system, Arrows can exist as signals, which can reside in memory. Arrows [608] and [609] emanate from source Points [605] to target Points [606] and [607]. Source Points include the Points Arrows emanate from; target Points are the Points Arrows emanate to. A Point may be both a source Point and a target Point. Arrows [608] and [609] represent computational history and are fundamental to the system's reactivity and ability to do incremental computing.

Arrows [609] show the computational history of the target Points [607] from the performance of Function [604c] on source Points [605] in Cell [601]. In other words, Arrows [609] give us the knowledge that Points [607] were created because Function [604c] was performed on all Points [605] in Cell [601]. Likewise, Arrows [608] give us the knowledge that target Points [606] were created because Function [604b] was performed on all source Points [605] in Cell [601]. So, as explained, the Arrow is a representation of how a Point was created (its computational history), as governed by the logical decomposition of stage [203] of FIG. 2 rather than a link to information located outside of the Cell. An Arrow emanating from a source Point to a target Point shows the computational history of the target Point is dependent on the source Point. Said another way, all information in the Cell is self-contained.

Taking a step back from individual Arrows, it is valuable to examine the interaction among Cells and Arrows. All Cells are aware of all Arrows which emanate to and from itself. The Cell's awareness of the Arrows which interact with it give the Cell awareness of the Arrow's history (what function created the Arrow, and to or from what Cell that Arrow emanates). This knowledge allows the Cell to effectively see representations of information flows within the system by analyzing its Arrows.

Arrows allow for a reactive paradigm to exist in the system. Changes to information will propagate through the system and be displayed. Arrows provide a record of how Points are derived, so Points can be updated when source information or functional definition changes.

Arrows facilitate incremental computation in the system as signals are received so that small changes only require small transformations. In other words, the whole processing and display system does not have to be re-computed. With the knowledge provided by Arrows [608] and [609], when information changes in the system, the entire system does not have to be re-computed, but, only dependent information affected by the change has to be re-computed by finding where Arrows emanate from and where they emanate to.

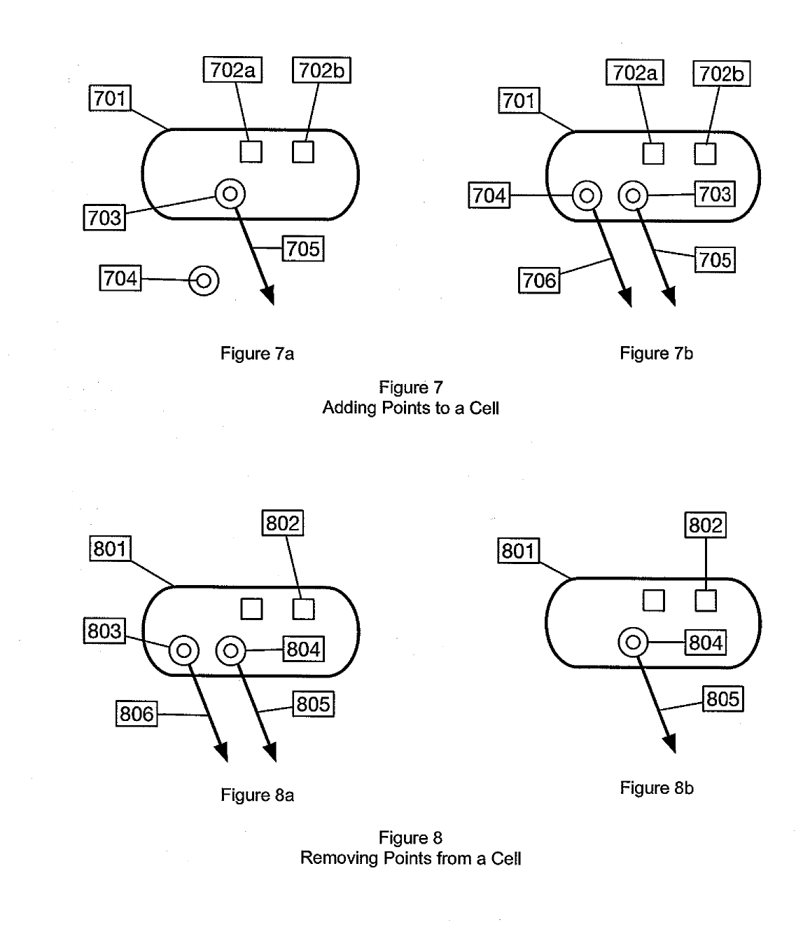

For example, incremental computation occurs when a first new Point is added to a first Cell triggered by a signal. All functions existing in the first Cell should be performed on only that first new Point, creating any necessary Arrows and Points. If a second new Point in a second Cell is created by that or a subsequent signal, then the process repeats itself for that second new Point (all functions in the second Cell are performed on the second new Point). The process can repeat itself again, as necessary. A detailed description of adding new Points to Cells is described in FIG. 7 and its corresponding description.

A very simplified set-theoretic, but non-limiting, example of FIG. 6 as applied to information as information follows. The five Points [605] in Cell [601] represent the information set of information {11, 2, 3, 4, 51}, respectively. Function [604a] extracts all negative numbers. Function [604b] extracts numbers less than or equal to 3. Function [604c] extracts all odd numbers greater than or equal to 3. Function [604a] has been performed on all Points within Cell [601], as there are no negative numbers, there is no resultant transformation of information, and no Points or Arrows the result of Function [604a] exist. Function [604b] has also been performed on all Points within Cell [601]. As there are odd numbers, Cell [606], corresponding to Function [604b], is populated with resultant Points [606]. The three resultant Points represent the information set {11, 3, 51}. Arrows [608] show the computational history of the resultant Points. For example, the leftmost Point in Cell [601] correlates to the leftmost Point in Cell [602]. Both those Points represent the number 1. The Arrow emanating to the leftmost Point in Cell [602] represents the computational history showing the Point was transformed from information in Cell [601] as a result of Function [604b]. Likewise, Function [604c] is applied, and resultant Points [607] representing the information set {1, 51} populate Cell [607], corresponding to Function [604c]. Arrows [609] emanating to Points [607] show Points [607] computational history from Points [605]. This transformation of information from Cell [601] to Cells [602] and [603] can be processed on either server processor or client computers. Furthermore, the processing elements of either servers or clients compute the necessary transformations. The resultant information, the Points, are stored on the memories of either the server or the client processors.

As illustrated in FIGS. 7-10, a variety of operations may be performed on a Cell.

The operation of adding a Point to a Cell is shown in FIG. 7, showing a Cell before and after a Point is added, respectively. As shown in FIG. 7a, a new Point [704] is to be added to an existing Cell [701], with an existing Point [703], existing Functions [702] and existing Arrow [705]. As shown in FIG. 7b, Point [704] is added Fo the Cell. All functions [702] in the Cell [701] in FIG. 7b are performed on the added Point [704], resulting in a new Arrow [706] emanating from the added Point [704]. The new Arrow Points to the Cell where the resultant transformation of information would be stored (Cells not shown). There is no need to re-perform functions on existing Point [703], which has previously been computed. This and other behavior is a result of the set-theoretic rules governing the functional composition.

A simplified, but non-limiting, example of FIG. 7 as applied to information as follows. Point [704] (the Point to be added) represents the number 2. Point [703] represents the number 1. Function [702b] transforms information within its Cell to extract all numbers less than 3. Arrow [705] represents the computational history showing Point [703] has been transformed and a resultant Point created. In FIG. 7b, Point [704] is added to Cell [701]. After adding the Point [704], all functions in Cell [701] are performed only on Point [704]. So, Function [702b] is only performed on Point [704], representing the number 1. As 1 is less than 3, a new Point representing the number 1 is created, and placed in a Cell corresponding to Function [702b] (not shown). Arrow [706] is created and represents the computational history showing Point [704] has been transformed by Function [702b]. This transformation of information instances can be processed and stored on either Topoiesis Server [105] or Client [107] computers.

Another operation, removing a Point, is shown in FIG. 8, showing a Cell before and after a Point is removed, respectively. In FIG. 8a, existing Point [803] is to be removed from existing Cell [801], the Cell also comprising existing Point [804], Function [802], and Arrows emanating from the Points, [805] and [806]. As shown in FIG. 8b, existing Point [803] and corresponding Arrow [806] have been removed. Removal implies deletion. All other components of the Cell remain. Additionally (not shown), any Points (not in a top-level Leaf) which do not have any Arrows emanating to themselves (as a result of Arrow removal) are removed and deleted by this same procedure.

A simplified, but non-limiting, example of FIG. 8 as applied to instances of information follows. Point [803] (the Point to be removed) represents the number 1. Point [804] represents the number 2. Function [802] transforms information within its Cell to extract all numbers with value less than 3. Arrows [805] and [806] represent the computational history showing that Points [803] and [804] have been transformed and resultant Points created. In FIG. 8b, Point [803], representing the number 1, is removed from Cell [801]. The corresponding Arrow [806] showing the transformation of the number 1 via Function [802] should also be removed. If the Point Arrow [806] had emanated to have no Arrows emanating to it, that Point should also be removed in accordance to this procedure. This transformation of information instances can be processed and stored on either Topoiesis Server [105] or Client [107] computers.

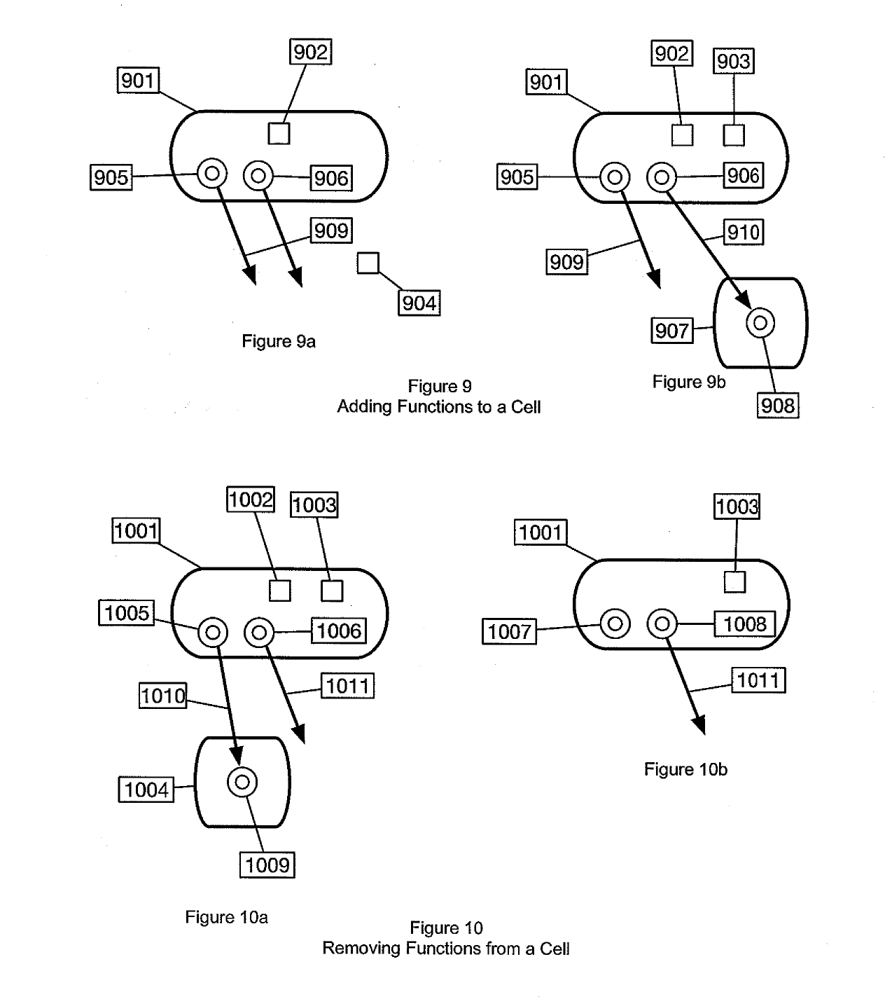

Another operation, injecting a Function into a Cell, is shown in FIG. 9, showing a Cell before and after a Function is injected, respectively. In FIG. 9a, a Function [904] is to be injected into an existing Cell [901], the Cell also comprising existing Points [905] and [906]. existing Arrow [909], and an existing Function [902]. In FIG. 9b, injecting the Function [904] into Cell [901] results in the creation of a new Cell [907]. The injected Function [904] is then performed on all Points [905] and [906]. In this example, performing the injected function on Points [905] and [906] results in the population of the new Cell [907] by resultant Point [908]. A created new Arrow [910] shows the computational history of Point [908].

A simplified, but non-limiting, example of FIG. 9 as applied to instances of information follows. Point [905] represents the number 1. Point [906] represents the number 2. Function [902] transforms instances within its Cell to extract all odd numbers. Function [904] (the Function to be injected) transforms instances within its Cell to extract all even numbers. Arrow [909] represents the computational history showing Point [905] has been transformed and resultant Points created. In FIG. 9b, Function [904] is injected into Cell [901], and Cell [907] corresponding to Function [904] is created. Function [904] is performed on all Points [905] and [906] within that Cell. As Point [906] represents the even number 2, resultant Point [908] representing the number 2 populates Cell [907]. Arrow [910] is created, emanating from source Point [906] to Point [908], and represents the computational history showing Point [908] was created because Function [904] was performed on Point [906]. This transformation of information instances can be processed and stored on either Topoiesis Server [105] or Client [107] computers.

Another operation, removing a function, is shown in FIG. 10, which illustrates a Cell before and after a function is removed, respectively. In FIG. 10a, existing Cell [1001] comprises Points [1005] and [1006], functions [1002] and [1003], and Arrows [1010] and [1011]. It is noted that Arrow [1010], Cell [1004] and Point [1009] are all the results of the performance of Function [1002]. In FIG. 10b, Function [1002] is removed, hence all Arrows created due to Function [1002] are also removed. Hence, Arrow [1010] is removed. As Point [1009] no longer has any Arrows emanating from it, the Point is removed (in accordance to the Point removal procedure, described above). Additionally, Cell [1004], corresponding to removed Function [1002], is removed. Cells, Points, and Arrows which have been removed are necessarily deleted.

A simplified, but non-limiting, example of FIG. 10 as applied to instances of information follows. Point [1005] represents the number 1. Point [1006] represents the number 2. Point [1009] represents the number 1. Function [1002] (the function to be removed) transforms information within its Cell to extract all odd numbers. Function [1003] transforms instances within its Cell to extract all even numbers. Arrows [1010] and [1011] represent the computational history showing Points [1005] and [1006] have been transformed and resultant Points created. In FIG. 10b, Function [1002] is removed from Cell [1001]. Arrow [1010] represented the computational history showing Point [1009] was created from performing Function [1002] on Cell [1001]. Point [1009] was a resultant transformation of information from Function [1002]. Cell [1004] had been created to be populated by resultant Points of Function [1002]. As Function [1002] is removed, the corresponding Arrow [1010], Point [1009] and Cell [1004] should all be removed and deleted. This transformation of information instances can be processed and stored on either Topoiesis Server [105] or Client [107] computers.

A separate operation is garbage collection. Garbage collection removes any Cell where all functions have been removed from that Cell, unless that Cell is specifically denoted as a Cell with only Points. The removed Cell and Points are deleted.

A few rules are observed during Cell operation. governed by set theory as applied to logic by means well known in the art. Arrows from multiple Points may emanate to a single Point. Changes to a Cell may potentially affect all dependent Cells. In general, the resultant Points of a Function populate a single Cell created to store the resultant Points of that Function. However, it is possible for a function to loop back within the Cell; i.e., Arrows emanating from a Point emanate back to that Point. Each Point is uniquely identifiable. It is possible that an empty Cell exists; i.e. a Cell is created for a Function to fill with transformed information (Points), however, the function results in no resultant Points. There exist primitive Functions which perform basic Cell operations, including creating Cells. Furthermore, primitive Functions preexist in Cells. That is, they do not have to be “injected” for a Cell to perform the particular functionality. Other Cell functions which exist may be filtering, mapping, ranging, inverting, etc. Those other Cell Functions are not preexisting, and may be injected into a Cell when performance of a particular function is desired. The requirement for or source of such a particular Function can be on the client or on a server, under the control and knowledge of the system or unexpectedly supplied.

Arrows allow Cells to keep track of computational history. The underlying formal Situation Dynamics are indicated in FIG. 2. Inputs from the user via state [209] are in a structured logical form. Operations at states [203], [205], 207] and [209] are logical in the sense well known in the art. These can be supported by common reasoning and display infrastructure such as provided by Windows™, Unix™, Macintosh™ and GPU suppliers through systems such as OpenGL and OpenCL™. There are few restrictions on the logical conveyance and operation at this level, and advanced input devices can readily be supported providing that they use computational methods that are logical. This can include advanced input methods such as haptics, holograms, speech and eye, muscle and brain wave sensors. Arrows enable the undoing or recomputation of past computations, and the comparison of past computations to current computations. The use of Cells, Points, functions, and Arrows allows the system to have the ability to inject/remove functions or add/remove Points into Cells such that the changes propagate throughout the system in real-time, while the system is functioning. This can be centralized or decentralized and incorporate components and operations not explicitly shown.

Operation at the level of states [203], [205], 207] and [209] are novel. As just described, the functional composition of sets and Cells from infons is guided by instructions provided by the decomposition of the infons into elements that can inform the process just described, with Cells, Points and Arrows. This conforms to axiomatic rules concerning set theory and logic which are well known in the art.

FIG. 11 illustrates the Functional Reactive Fabric. The reactive functions employ the functional programming paradigm. It is well known in the art that functional programming can be formalized in category-theoretic terms.

Of special note is the use of the term “function.” Common, procedural programming paradigms have functions. We use the term exclusively in a different programming paradigm, that of so-called “Functional Programming.” Functions in this paradigm have a different meaning and are related to the mathematical notion of function rather than the procedural definition, which is an operation.

Functions in functional programming have radically different properties than those in procedural languages. One of these is that with care, functions in the functional paradigm can be manipulated and created as mathematical objects using certain mathematical theories. The described embodiment creates functions automatically using set theory by the Cell generation method described. Thus, the functions in the Functional Reactive Fabric are wholly synthetic, as a novelty of the invention.

Moreover, the functions in the Functional Reactive Fabric are reprogrammed using category theory, via the Situation Dynamics of state [211]. The code of the Dynamics Reasoner [211] is initially hand-coded. The code of the Functional Reactive Fabric is always automatically generated as described, by both the set theoretic Cells and the category theoretic Situation Dynamics.

The different between the procedural and functional paradigm is well known in the art. Examples of procedural languages are Basic, C, C++, C#™, Java™, and Python™. Examples of functional languages are ML, Haskell™, Erlang™ and XSLT.LISP was designed in the 1950s as the first functional language, roughly at the same time as FORTRAN was designed as a procedural language. Both use the term ‘function’ but in different ways.

It should also be noted that functional programming has a relationship with mathematics, in that as noted there is an equivalence between functional code and mathematical expressions. By the afore-mentioned Curry-Howard-Lambek correspondence, any mathematical expression can have a corresponding expression in functional code and vice versa. Notwithstanding this, the only mathematics required for the described embodiment are the set theoretic operations previously described in conjunction with FIG.s

A good reference for functional programming is “Purely Functional Data Structures” by Chris Okasaki, Cambridge University Press, 1999.

It should be further noted that functional reactive programming is a specific technique within the functional paradigm. Though the term “reactive” could be applied to other programming techniques, and “reactive programming” can be implemented using a procedural paradigm, functional reactive programming is distinct.

We leverage the functional aspects by allowing code in the system to use set-theoretic mathematics to create code in the Functional Reactive Fabric. We leverage the reactive aspects to have the functional “pipelines” of the Fabric to remap Ontological Graphs. A reference on functional reactive programming is by Conal Elliott. “Declarative Event-Oriented Programming, in the Proceedings of the 2nd International Conference on Principles and Practice of Declarative Programming, ACM Press, 2000.

An illustrative contrast is with the system of Reed et al Patent Number 2002/0095454, wherein is described a system that persistently transforms data.

The code in Reed uses an object-oriented methodology within the procedural paradigm in contrast to the functional paradigm of the present invention. The transforms are hand coded in contrast to the present invention where a distinct novelty is that the transform code is automatically generated. The transforms could conceivably be considered reactive because they are chained methods, but they are stateful as an artifact of the object paradigm in contrast to the present invention in which the Functional Reactive Fabric is stateless.

The transforms are over well typed data in contrast to the present invention where diverse information is readily accommodated, including streaming sources and multi-ontology heterogeneity.

The data transforms in Reed are not adaptive in contrast to the novelty of the present invention where a central advantage is that the Functional Reactive Fabric adapts constantly and automatically (or by human direction) to re-interpret information semantics situationally. The data transforms of Reed are specifically algorithmic. This means that inferences, transforms and analyses are performed on the data itself. In stark contrast, the present invention forms a Functional Reactive Fabric to provide deep semantic context for inferences, transforms and analysis outside the system, either by legacy integration via state [207] or [209].

Reed requires a query to select information and is basically a means to deliver a specific result. The present invention ingests the entire corpus via lazy evaluation to deliver appropriate results regardless of how precise the initiating action was.

Reed works exclusively within a one-sorted logic. The present invention has as a significant novelty the ability to manage two-sorts, via state [211].

Notwithstanding the fact that information flowing through the Functional Reactive Fabric is processed by set-theoretic logic, and further notwithstanding the similar fact that operation of constructing and managing the Cells by the translation of the inputs from the user is performed by using set-theoretic logic, the relationship between the Cells, Points and Arrows and the Functional Reactive Fabric, is governed by category theory.

In this fashion, the system is capable of supporting a two-sorted logic. Such logics are known art; they are often employed for reasoning in context, where one logic reasons over context and the other reasons over facts and inferences performed in those contexts. A well known implementation of two-sorted logic for general reasoning is situation theory. A reference for situation theory is “Logic and Information,” by Keith Devlin, 1995 (Cambridge University Press). A modern reference is “A Two-sorted Logic for Structurally Modeling Systems,” by H T Goranson and Beth Cardier, Progress in Biophysics and Molecular Biology, 864.doi:10.1016/j.pbiomolbio.2013.03.015. This latter is included in

An example of situation theory may involve an analyst who wishes to evaluate a set of facts two different ways. Perhaps one way would be as a fact based engineering specialist may reason about the facts, performing certain inferences. A second way might be how a third world religious zealot may reason about the same facts in a different context, drawing different conclusions. In each case, a different ontology governs the creation of the Cells, resulting in a different Functional Reactive Fabric. The two-sorted behavior is apparent in the Dynamics Reasoner [211] of FIG. 2 that ‘reasons about’ another logic, the Fact Reasoner [207]. It is of course possible to have a third ontological context, one in which a third reasoner sees, understands and reasons about the difference between the engineer and the zealot.

FIG. 11 is a first embodiment illustrating a category-theoretic system as the framework for managing information flow, implemented using a client-server distributed computer system. The basic components of the system of FIG. 11 include the Topoiesis Server cloud [1102], the server-client boundary [1104], the Clients [1113], output to user interfaces [1114] (perhaps through a stage [209] of FIG. 2) and the logical link between the Clients [1113] and the Topoiesis Server-specific Leaves [1106]. The model further comprises Leaves [1106], [1108] and [1111] and reactive transformation of information [1107] and [1109].

The Topoiesis Server cloud [1102] is a logical representation of a single server, but may comprise a plurality of servers net-worked together with communication devices. Servers are computing devices which host and perform actions on information. The Topoiesis Server cloud [1102] can communicate with satellite servers [1103]. Satellite servers [1103] may be servers with information storage and information access capabilities via Information Servers [103] of FIG. 1. Satellite servers can communicate with Clients [1113] to provide them with processed information. Clients can be any type of computing device, including personal computers, embedded processors including those in military systems, smart phones, tablets or other mobile devices. Clients may request services from servers, but may also perform actions on information. In this embodiment, Clients [1113] support Fact and Situation Presentation services [209] and [213] which provide users appropriate information displays and the ability to manipulate information. While only one Client [1113] is shown, the system may comprise a plurality of clients.

As it is well-known in the art, both servers and clients comprise at least one processor and memory. In the present invention, servers and clients both perform functions by a processor which processes and transforms information delivered from elsewhere and information stored in their memories. As will be discussed below, the processes of performing functions on information are accomplished through functional programming and incremental computing.

It should be noted that the present invention can be integrated into other systems to support additional services. For example, the servers of FIG. 1 only support the services described. Information Servers [103] provide the specific service of ingesting information and meta-information into the system. Topoiesis Servers [105] provide the service of building and operating the Functional Reactive Fabric and supporting the reasoning and formatting services of states [207], [209], [211] and [213].

As previously described, certain services can be shared between Information Servers [103] and Topoiesis Servers [105]. Further, it is novelty of the invention that some services can be dynamically assigned for execution on Topoiesis Servers [105] and Clients [107].

Other services will require servers not shown. For instance, should the system need a print server, this can be supported by means not shown and not central to the invention. Similarly, already discussed is the ability to integrate one or more servers with the functions associated with state [207] to support legacy reasoners. These are outside the scope of the invention, apart for the novel ease with which they can be integrated.

Other special purpose and general purpose servers and clients can be integrated as needed. Of special note are optional Satellite Servers [1103] of FIG. 11. These can optionally manage the client-server boundary of the Shared Code, manage loads and integrate with other services, for example security services.

Similarly, the system of FIG. 1 does not provide every service that a client may require. Additional clients or servers can be added to support some task not described herein, for example instant messaging.

Leaves [1106], [1108] and [1111] are discrete, logical containers, each containing information and functions. Topoiesis Server processor-only Leaves [1106] exist only on a Topoiesis Server and store information that are the basis of transformed information. Topoiesis Server processor-only Leaves [1106] can be the top-most layer of Leaves in the system. The top-most Leaves often contain information which the system manages and manipulates. There are Leaves [1108] existing on both Clients and Topoiesis Server; those Leaves contain functions and information which both Clients and Topoiesis Server access. Leaf [1111] is a bridge, which simulates having a direct line from the Topoiesis Server to the Client. Bridges are set up to traverse the server-client boundary [1104] so that the Topoiesis Server and Client can communicate. There are also Client-only Leaves [1112], containing functions and information that only clients will need to access. Changes to Leaves propagate throughout the Functional Reactive Fabric, discussed in further detail below. Leaves can comprise any information structure, for example, numbers, strings, Boolean values, or any object in an object-oriented system. Additionally, they can comprise functions. Finally, they can comprise Cells, which are reactive (changing) values, as described below.

The Functional Reactive Fabric further comprises transformations of information [1107] and [1109]. Transforms of information contain information resulting from a function performed on other information. Transformations of information [1107] and [1109] are self-contained, and are stateless. They can exist on servers or clients. They provide views of the information store, and importantly, can be reactive to changes in the information store. Transforms of information comprise Cells, described in FIGS. 6-10.

Information in transforms of information [1106] can be further processed and transformed resulting in other transformations of information [1109]. Because such transformations of information are self-contained, resulting information is passed throughout the system via messages passed along, for example, path [1110]. This architecture allows the system to thereby function in a distributed manner, as in a distributed computer system where each component is independent and self-sufficient. This allows for scalability and adaptability to components added to or removed from the system without affecting the system's functionality.

The architecture further comprises consumers of information, which are also bridges, traversing the server-client boundary so that the server and client can communicate. They can act as repositories to store and pass along information. Examples of repositories that store and access information include storage devices such as hard drives, RAID devices, other information servers, and mass or discrete storage units.

The Clients [107] (or Topoiesis Servers [105]) of FIG. 1 provide at least one Formatter Service [209] or [213] of FIG. 2 which, among other things, allows a user to view the information on the system. The Formatter Service also allows a user to query the system and view the result. The user interface allows a client user to manipulate Leaves [1106], [1108] and [1111] through the Client [107] (and hence, propagating changes throughout the entire Functional Reactive Fabric).

The server-client boundary [1104] is the separation between Topoiesis Server and Client. The boundary is set to optimize functioning of the system, taking into account factors including bandwidth, latency, computing power, memory, and security requirements. The factors are considered because the boundary [1104] must react to changing conditions in order to maximize efficiency when performing computations. This allows for a system novelty in that there is flexibility where the boundary is set. That is, the Functional Reactive Fabric may have Shared Code and decide to assign the responsibility for a transformation to either the Topoiesis Server of Client, dynamically “moving” the server-client boundary [1104]. For example, transformation [1109] is computed by the Topoiesis Server, but, by moving the server-client boundary to encompass transformation [1109], the transformation could be computed by the Client.

The link [1105] between Client [1113] and Topoiesis Servers [1102] allows the user to interact with the system and change values on the server. This is equivalent to the connection [215] of FIG. 2, accomplished through the user interface connected via state [209]. There also may be additional user interfaces associated with states [207], [211] and [213] with similar feedback mechanisms not shown. Other users can concurrently access such information, which may run on the same or on separate clients. All users may use any user interface to view the current state of information, or to query the system, in real-time.

FIG. 11 also illustrates the Fabric's reactivity where changes to Leaves in the Fabric will propagate throughout the whole Fabric. For example, the Fabric may currently have a particular representation of information in the Fact Formatter [209]. However, the user may wish to change information in the server-only Leaves [1106]. If the information in the server-only Leaves [1106] is changed, then the resultant transformation of information [1107] may change. The change to resultant transformation [1107] may also affect the resultant change in transformation of information [1109], and so forth down the model, over the bridge between the consumer of information and Leaf [1111], back down to export to the user interface.

Those changes propagate throughout the system, but only affect components related to the change, potentially resulting in a change to the final display of information on the Client [1113] and export to the user interface. It is important to recognize that the change to the top-most Leaf, in this case the Topoiesis Server-only Leaf [1106], results in changes throughout the system, and are shown in real-time. Because the system reacts to changes in real-time and all entities connected to the system can access the most up-to-date information concurrently, the system facilitates a reactive paradigm. Likewise, a change in Leaf [1111] would force a change thought the system, changing any transformations dependent on the Leaf.

It is also important to note that embodiments can easily be created that follow an autonomous agent self-organizing paradigm. In this approach, the feedback loop [1105] will carry additional information about “reward” for value added by each function. This feedback loop would in this case additionally extend to fundamental information sources [101] and [102] of FIG. 1 (stage [201]) of the embodiment described in the figures.

Referring now to FIG. 2, information is received at state [201]. It may in the forms already described. At state [202] the infons are formed according to the description associated with FIG. 3 and the previously noted reference “A Two-sorted Logic for Structurally Modeling Systems.” State [202] also transcribes the Topoiesis and Ontology Infons and their associated Ontology Graph (in its current form) to Cells by the tracing method described. State [205] uses those Cells to construct the dynamic Functional Reactive Fabric of FIG. 11.

Facts may be altered or entered by a user, including nuance of interpretation. These alterations are referenced back by the loop [215]. Facts are represented by Cells and at the atomic level by the Points [505] of FIG. 5. Any change in facts, via either the loop, some new or changed fact from the sources or stores [201], or by effects from the second sort of category logic at state [211] and fed back by loop [214].

Situations may be altered, created or enhanced by a user or by results from an automated reasoner using tools at state [211]. These are represented in Cells as the collection of functions in Cells [503]. Changes in either sort change the Functional Reactive Fabric of FIG. 11. That is, changes from work on the right hand side [310] of situation theoretic equations [311] of FIG. 3 supported by the Fact Reasoner [207] or changes on the left hand side of situation theoretic equations [313] supported by the Dynamics Reasoner [211] can both change the Cells and thus the Functional Reactive Fabric.

Referring now to FIG. 3. The Topoiesis Infon [302] is the normal form for facts in the system. Parameters [305] are tokens representing concepts that have associated Ontology Graphs as shown in FIG. 4. Relations [304] are similar tokens with similar Ontology Graphs with the added quality that they directly influence the interpretation of the parameters.

Topoiesis Infons are related to one another by the connections in the Functional Reactive Fabric of FIG. 11, which reassembles the Ontology Graphs and its Topoiesis and Ontology Infon constituents and otherwise colors interpretation via structured Situation Dynamics on the left hand side.

The system reflects these changes on the interpretation on Topoiesis Infons by storing the fractional transforms for each Topoiesis Infon within the infon. The Ku Function [306] is the function that captures this. For example, we may have a fact “Mary ran to the store” and an associated Topoiesis Infon [302]. That fact wil have come situated, so for example we will know it occurred in the past and that the past tense applies. We may assume that Mary is a human female. These situated influences will be reflected in the Functional Reactive Fabric of FIG. 11.

Suppose now that a user working via a user interface supported by state [209] of FIG. 2 adds a new piece of information, that “Mary is a dog.” This may have profound implications on other inferences, perhaps by collaborators using networked Clients. The change in the Functional Reactive Fabric is fractionally stored in the Ku Function [306], conveyed to state [203] and appropriately stored at [101] and [102]. In the future, anyone accessing that fact will have the information necessary to construct the influenced Ontology Graph (that indicates Mary is a dog) and this allow for an initially correct (so far as is known) Functional Reactive Fabric.

The Ku Function can have several components, shown as [307], [308] and [309], according to the complexity of the category theoretic Situation Dynamics supported by the Dynamics Reasoner [211]. Example components have been described.

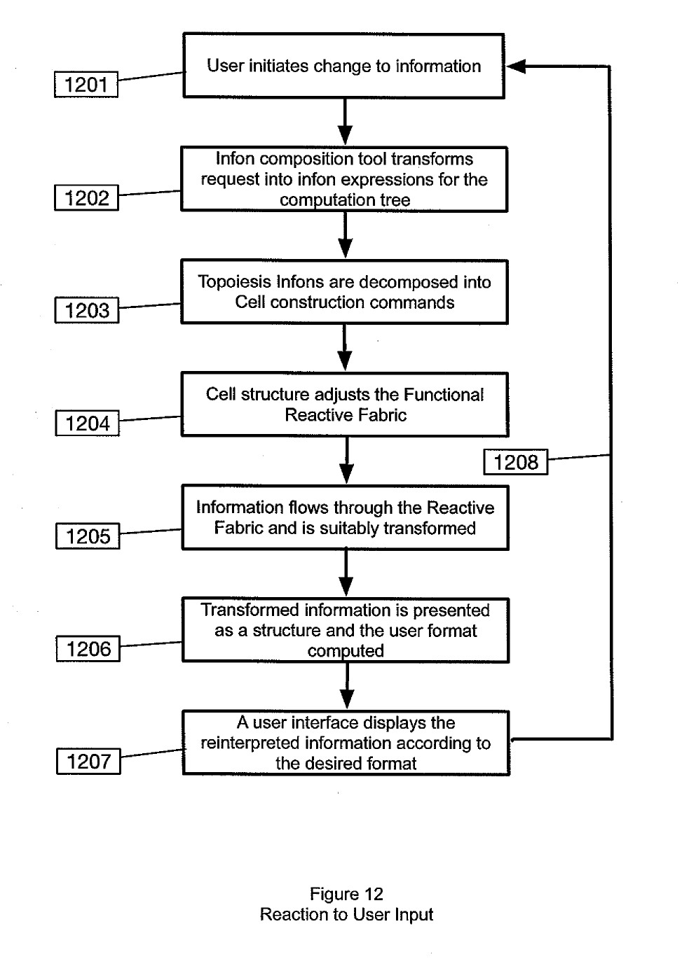

FIG. 12 shows the system in an exemplary operation responding to a user-initiated change in fact. Using the example given above, at step [1201] the user invokes the desired information including the example fact “Mary ran to the store,” and enters the information that “Mary is a dog.” If not already composed as an Infon, it is thus composed [1201].

At step [1202] the Topoiesis Infon and its default Ontology Graph is collected. This includes, for example Ontology Infons that define what a dog is.

At step [1203] the infons (both Topoiesis Infons and Ontology Infons) are traced into Cells. Not shown in the diagram is a step which may be executed by an automated expert reasoner adding new information that this insight provokes.

At step [1204] the Functional Reactive Fabric is created. The Reactive Fabric persistently modifies the default interpretation that Mary was a female, presumably young and fit enough to run, to a quite different interpretation. Not shown in the diagram is the fractional parser that separates out the Ku Function for storage with the Topoiesis Infon. The Ku function, it should be noted, does not contain the information that Mary is a dog. Nor does it contain a Pointer to that information as would be usual in a current knowledge representation system. The Ku Function contains information that when combined with other Ku Functions from other facts affects the construction of the Functional Reactive Fabric such that the default Ontology Graphs of all facts is suitably adjusted.

This is a key feature of the invention because it can readily account for massive numbers of perhaps subtle and indirect ontological nuance.

Step [1205] has the Fabric suitably adjusted to change the Ontology Graph associated with the token “Mary” to account for the fact that Mary is a dog. Note that salient subtleties may be preserved, so that further information may adjust the Ontology Graphs to imply that Mary is indeed human but not pretty.

Step [1206] is handled by State [209] of FIG. 2 to convert the now filtered Topoiesis Infons and associated Ontology Graphs to the form desired for effective display in the user interface where it is displayed [1207]. A user may modify some quality of what is displayed, entering a new fact or changing some existing fact. That will begin the process again [1208].

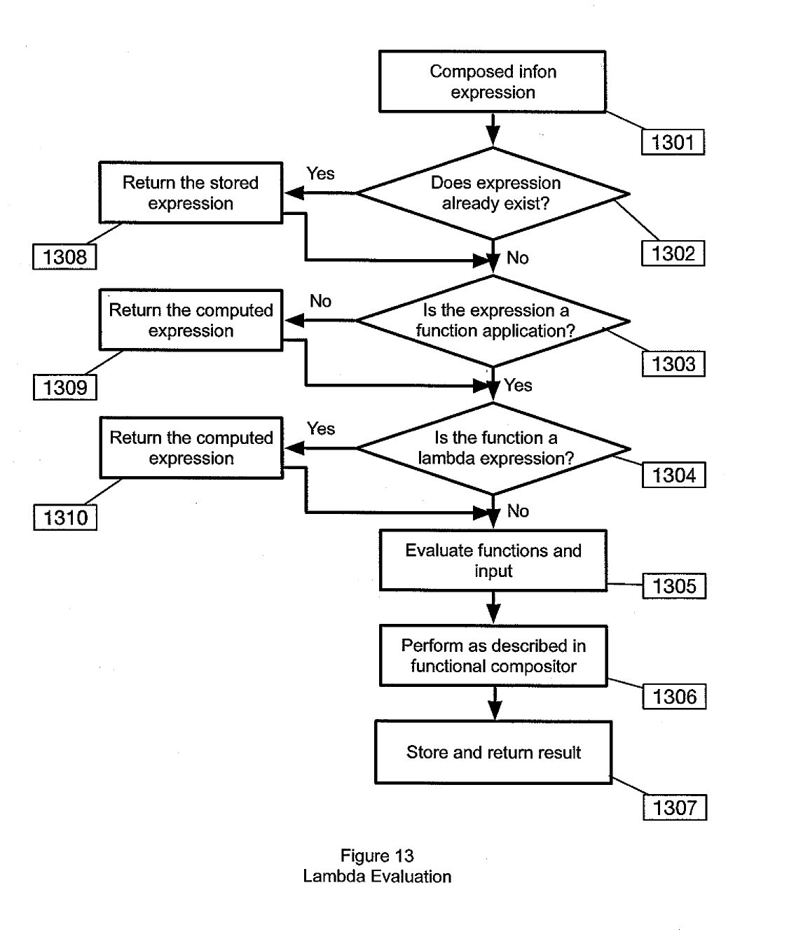

FIG. 13 details the process of evaluating expressions, creating the computation tree, in part using lambda calculus. Step [1301] begins with the expression to be evaluated. The expression to be evaluated is generated from user input. Expressions are defined by literals (numbers, strings, Booleans, and other information structures), objects, primitive functions, and variables that are introduced in lambda expressions. Step [1302] determines if the expression has already been evaluated by checking if the required functions have been performed yet. If it has, then the result of the already-existing expression can be returned at step [1308]. If the expression has not already been evaluated, it must be determined if the expression is a function application or an Information Point at step [1303].

An expression is a function application if it has a function and an input. If it is not, then the expression can be returned at step [1309]. A function is either a lambda expression or a primitive function, and is determined at step [1304]. A lambda expression is a known method to represent a function and define the transformation that the function performs on its arguments. Functions can be passed as arguments, or returned as results. The use of lambda expressions helps to facilitate the kernel's functional programming paradigm. If it is a lambda expression, then a beta reduction must be performed at step [1310]. A beta reduction is the process of computing the lambda expression (i.e. applying functions to their arguments). Beta reductions are performed through substitutions. Substitutions are the process of replacing all occurrences of a variable by an expression. The result of the beta reduction should be evaluated at step [1305].

If the function is not a lambda function, it is a primitive function and the system should apply the primitive function to the input, and evaluate that at step [1305]. Necessary functions are injected and necessary Cells are created. At step [1306], the system should perform the transformation of information, as described in the Cell implementation, which has been described above. The transformation of information step entails processing Points within Cells by functions as previously described. Finally, the result of the evaluation and transformation is stored and returned at step [1307].

FIG. 14 Illustrates how Topoiesis Infons can be nested to capture complex concepts. This figure is not necessarily part of the system, but, serves as an example of how information may be stored, and its subsequent processing, within the system. An example initial chunk of information is “An author is typing in Chicago.”

Infons are a way to decompose concepts that may also be presented in natural language. Topoiesis Infons are constrained to include two and only two parameters, so complex concepts and interpreted natural language must be represented by decomposition into tree structures. In practical systems, Topoiesis Infons are constructed with transformative relations, so any verb in a sentence would map to the relation. However, for clarity in this example, the relation will be “Is,” and the tense present tense.

is a single infon with one fragment of information. It is represented in the tree by nodes [1409] and [14140] joined by the “Is” relation. By nesting in an enclosing infon, we can represent the fact that an author is typing on a computer.

In this example, we will use informal notation with an implied “Is,” thus: “An author is typing,” composed in informal infon form is: <typing, author>. Furthermore, as sentences get more complex, infons may be nested. So, the sentence, “An author is typing on a computer,” in infon form is: <using. computer, <typing, author>>. Infons may be even further nested. So, the sentence, “An author is typing on a computer in Chicago,” in infon form is composed: <in, Chicago, <using, computer, <typing, author>>>. Nesting can continue without end.

The last example sentence is represented as a tree form information structure in FIG. 14. The tree comprises objects [1401], [1403]. Objects include the grouping of items, including the words “In” [1405], “Chicago” [1406]. and Cons [1401], shown in grouping 1 [1403] (represented by the dashed, lines). Cons in this context is an operator with the effect of the default relation.

All objects have the properties upLeft and upRight, which are a set of Cons. Cons [1401] are also objects. Cons are objects which comprise (in addition to upLeft and upRight) a left object [1402] and a right object [1404]. Ku functions, which would transform the graph to another are not shown here.

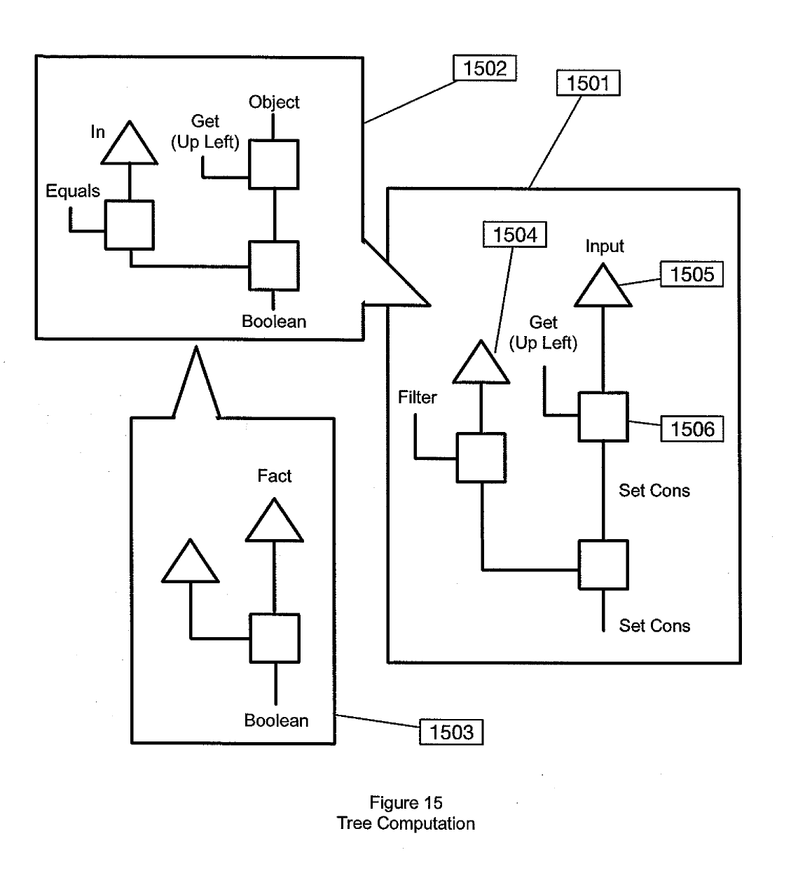

FIG. 15 is an example of a computation sequence. Grouping [1501] shows how information is transformed as it goes through Leaves and transformations. For example, Leaf [1505] contains information to be transformed at transformation [1506], and so forth. Grouping [1501] takes inputs [1504] and [1505] as well as a Function [1506] (and others as shown) to create the computation tree [1501]. Grouping [1502] is an example of functional programming, as it shows that input can be in the form of not just information, but also can be a function. In other words, Leaf [1504] can be the transformations performed by grouping [1502].

Furthermore, grouping [1503] shows a substitution, which is applied if necessary, as described in step [1305] of FIG. 13.

An example of the system managing and manipulating information to respond to a query follows. In this example, a user queries the system to find out where an author is typing.

On top-most Leaves [1106] the following information is stored: “An author is typing on a computer in Chicago.” That information is stored in infon format, which is represented by the tree shown in FIG. 14. That tree is stored as Points [605] existing in a Cell [601]. of FIG. 6

A user accesses the user interface via state [209] to examine the information current in the system, to for example find where the author types. When the user accesses the system, it renders the information in a situated form to the user.

The system then determines the server-client boundary [1104] in response to the query. Then, the Client [1113] applies template functions and requests the Topoiesis Servers [1102] to create computation trees, as described, via a link to the Topoiesis Server [1102], which picks the appropriate Leaves [1106] containing the information “An author is typing” Based on the user's input, the Leaves will start performing functions on the information, i.e., making transformations of information as needed and evaluating expressions, as shown in FIG. 13.

The system may need to add functions in order to properly respond. In that case, in server Leaf [1106], a function is injected into the Cell residing in that Leaf, in accordance with FIG. 9 as described above. The result of that function creates new Cell [907] and new Point [908]. The new Cell and new information correspond to transformation of information [1107]. In response to the newly created transformation of information [1107] a Point must be removed from transformation of information [1107]. That Point is removed in accordance with FIG. 8, as described above. The removal of the Point is yet another transformation of information.

On top-most Leaves [1106] the following information is stored: “An author is typing on a computer in Chicago.” That information is stored in infon format, which is represented by the tree shown in FIG. 14. That tree is stored as Points [605] existing in a Cell [601]. of FIG. 6

A user accesses the user interface via state [209] to examine the information current in the system, to for example find where the author types. When the user accesses the system, it renders the information in a situated form to the user.

The system then determines the server-client boundary [1104] in response to the query. Then, the Client [1113] applies template functions and requests the Topoiesis Servers [1102] to create computation trees, as described, via a link to the Topoiesis Server [1102], which picks the appropriate Leaves [1106] containing the information “An author is typing” Based on the user's input, the Leaves will start performing functions on the information, i.e., making transformations of information as needed and evaluating expressions, as shown in FIG. 13.

The system may need to add functions in order to properly respond. In that case, in server Leaf [1106], a function is injected into the Cell residing in that Leaf, in accordance with FIG. 9 as described above. The result of that function creates new Cell [907] and new Point [908]. The new Cell and new information correspond to transformation of information [1107]. In response to the newly created transformation of information [1107] a Point must be removed from transformation of information [1107]. That Point is removed in accordance with FIG. 8, as described above. The removal of the Point is yet another transformation of information.

The resultant Points are messaged down to client Leaves [1111]. At the Client, yet another Cell function may be performed, for example, filtering. Finally, after that transformation, the result has been determined. The Points are sent to the fact Formatter [209], which reports the result (“in Chicago”) in an appropriate form.

The user may subsequently determine some change must be made. For example, if the user learns that the author was in Chicago, but now is in Boston, she will manipulate the facts, using an interface associated with State [209]. The change is relayed up to the appropriate server Leaves [1106]. This change in information changes the top-most Leaves [1106], which in turn will affect all the transformations of information described above (but only the transformations which were necessary to the query). The system adapts to the change in information by following any Arrows emanating from affected Leaves [1106], and updating (adding, removing, etc.) the Arrows, as well as the resulting transformations of information and Leaves (comprising Cells, Points, functions), as necessary. The transformations, etc., propagate through the system, and the user should see the result of her input, a resituating from Chicago to Boston.

In parallel, another user, using another Client, could have been observing, in real-time, all the interactions, and manipulations that the other user has made. Similarly, the same user could adopt parallel perspectives where she is reasoning about information and at the same time reasoning about how she reasons about that information. This is a common scenario where a consumer of analysis wants to know not only the results, but how those results were obtained. This is why two-sorted logic is desirable and one reason the system supports it.

A specific advantage of the invention is that key information structures are managed in forms that are either intuitively accessible for a human user or can be made so. For example, Topoiesis Infons can be mapped to natural language expressions by simple techniques. If the Topoiesis Infons were generated by RDF triples, existing document-centric techniques from the Semantic Web can be employed to render assemblies in user-readable form.

As is apparent from FIG. 4, navigable Ontology Graphs are an intuitive display paradigm to envision and navigate the current interpretation of a Topoiesis Infon or statement captured in nested Topoiesis Infons. Ontology Graphs are directed acyclic graphs but in practice are primarily tree structures. We can readily display any Ontology Graph as a tree structure where certain nodes exist in more than one location at a time. In the art, this is called an “alias” or “coupled clone.” Outline displays are well suited for navigating such trees.

Outline displays are well known in the art. They form a primary navigation paradigm for file systems on Macintosh™, Windows™ and Linux™ computers, for example. A good reference for outliner control technology is from H. T. Goranson, on-line at http://atpm.com/Back/atpo.shtml (retrieved May 2013). Examples of outliner products include OmniOutliner™, Fargo™, Tinderbox™, MORE™ and NeO™.

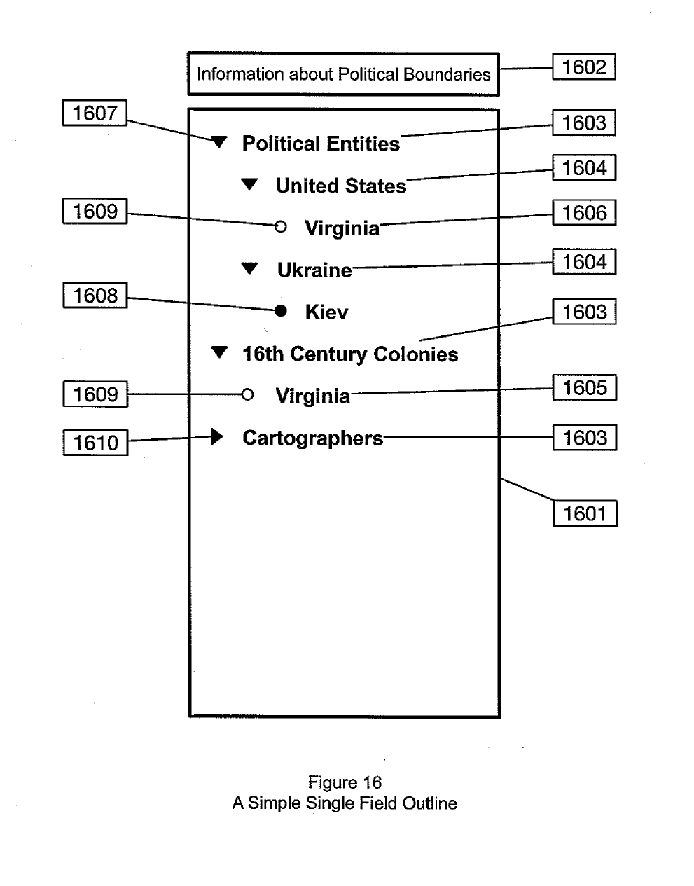

A representative outline is illustrated in FIG. 16. Outlines consist of nodes that are structured as a hierarchy. Many outliners allow the collapsing and expansion of nodes.

is the Field of the outline. Often, the Field has a name and metainformation. FIG. 16 has this as a separate label [1602].

Items [1603] are nodes considered first level entries, often called “parents” or “headers.” Nodes [1604] are nested under parents to denote that they are children in the hierarchy displayed. Nesting can continue to arbitrary depth.

Node [1605] is an alias of node [1606]. In FIG. 16 the convention is a hollow triangle. Aliases need not be at the same level of the hierarchy. The figure shows that node [1606] is three levels deep in the hierarchy whereas its alias [1605] is two levels deep. In terms of graphic display, it is possible to have aliases in circular configurations, for example a node being placed under an alias of itself. The embodiment described below follows techniques known in the art to prevent problems from circular assignments.

Aliases can be implemented in a variety of ways. It is common, for example for an alias to be an image of the original with a clear difference between the original and the alias. The difference is that deleting the alias deletes just the alias, whereas deleting the original deletes the original and (usually) all the aliases. In our described embodiment, an alias is as privileged as the original; once an alias is formed, both instances become aliases as long as multiples exist. Deleting any one leaves the others in the outline. An alias is often indicated by setting its entry in italics. In the described embodiment, it is indicated by a hollow control character [1609].

Aliases are also called linked twins, through many copies can be made. Linked twins inherit the children of the node in addition to other qualities.

FIG. 16 also shows one common convention for outline controls. [1607] is a disclosure triangle also sometimes called a “flippy triangle.” In the described embodiment, when the triangle points horizontally to the right [1610], the node is collapsed and children are “hidden.” When the node is pointing downward [1607], the node is expanded, usually to its last expanded state. When it is a dot [1608], the node has no children. When either an arrow or dot is hollow, it has a linked twin (an alias) somewhere. Many different conventions for these functions are currently employed in the art, and others are possible. The figure shows a common convention, but the embodiment is not limited by this.

Outlines with a single Field [1601] are common in the art. The invention employs multiple Field outlining with typed links between outlines. These leverage specific structure in single Fields. Outline Fields can be freeform as shown in FIG. 16, but many possibilities can be supported by an example user interface supported by state [209] of FIG. 2.

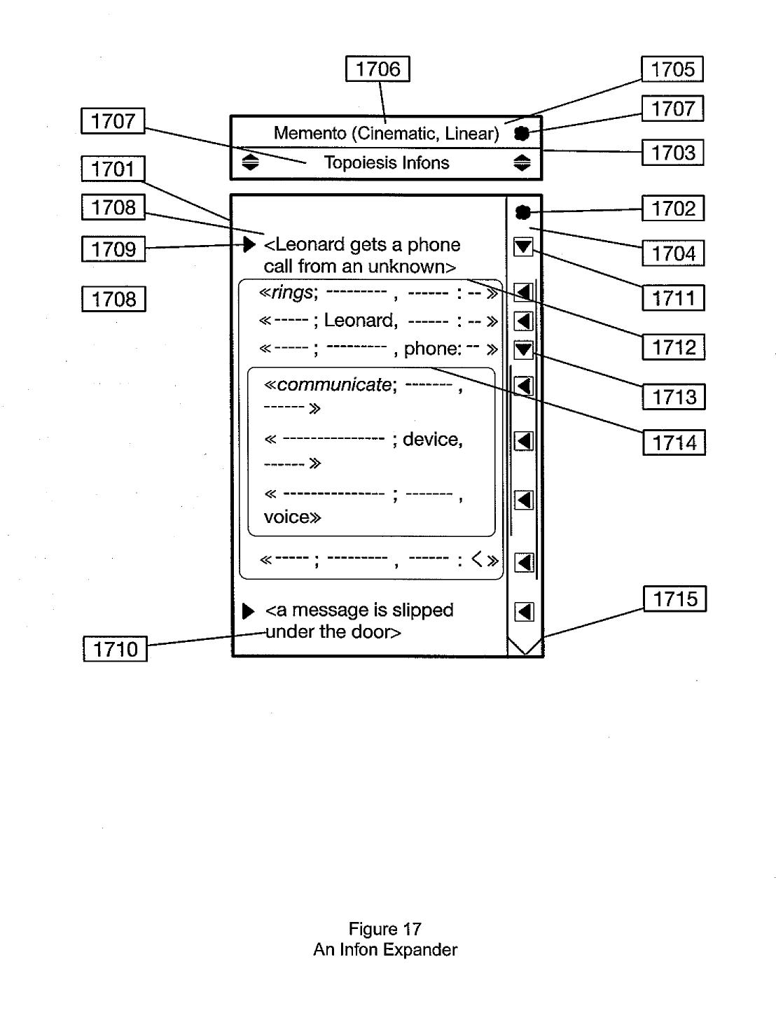

FIG. 17 illustrates an example but not limiting means of showing a sequence of information (and its decomposition) that is chunked into Topoiesis Infons. The Field of the outline is [1701] equivalent to [1601] of FIG. 16. The upper right of the Field contains an Option Control [1702], which if not activated appears alone with no controls below it. If activated, a popup menu (not shown) provides for allowing the appearance of the Label Field [1703] and/or the Infon Control Gutter [1704].

The Label Field [1703] has two zones. The top zone [1705] contains the name [1706] assigned to the Field. This name serves the purpose of advising collaborating users on the contents of the information in short form. The zone contains an expanding Option Popup [1707] which displays a popup inspector (not shown) that has more detailed information about the contents. For example, the more detailed information may include a longer description, the source, the storage, the trustworthiness, the age and so on.

A second zone [1707] contains the Option Popup list (list not shown) to select the nature of the outline display. FIG. 17 shows the Topoiesis Infon decomposition. When this is selected, each entry in the main outline is displayed in single carats, being a natural language expression of the fact. Entry [1708] is such a fact. Its outline control (the disclosure triangle) [1709] indicates that there is more detail. In this example, the entry “Leonard gets a phone call from an unknown” is a scene in a film and children of that entry may provide details about plot, cinematic expression and any other desired annotation.

Entries [1708] and [1710] in this example are sequences in a narrative construction, so that interpretations in the Ontology Graph of any one entry or its children can affect the Ontology Graph of all other entries, as previously described. FIG. 17 illustrates the state where the control [1702] has been toggled to display the Infon Control Gutter [1704].

The Infon Control Gutter contains controls that look and act much like those illustrated in FIG. 16. However, they are on the right hand side and contained in boxes. A dot (not shown) indicates that you have gotten to the end of a branch in the hierarchy. The triangle pointing to the left is collapsed, meaning that no detail of the infon is displayed.

illustrates a disclosure triangle that has been turned down by clicking to display detail of the infon [1708]. The outline entry [1708] is displayed in natural language form, a preference that can be changed to display in formal Topoiesis Infon Form. The expanded information is in formal Topoiesis Infon form. An entire panel is expanded, contained in an interior Field [1712] illustrated here as a rounded rectangle. It contains four entries, one each for each of the four elements of the Topoiesis Infon, the relation (in italics), the two parameters and the Ku function. Each of these is displayed on its own line with its own disclosure triangle because each can be expanded for their internal structure.

The Topoiesis Infon parameter “phone” has been expanded, as shown by the toggled control [1713]. This has “opened” the first tier Ontology Infon in the Ontology Graph. Typically several Ontology Infons will be opened for each expanded infon item (relation or parameter). Ontology Infons have three constituents, each displayed on its own line and enclosed in a rounded rectangle Field [1714].

Any number of elements can be simultaneously expanded. As in FIG. 17, if the displayed Field [1701] is not large enough for the expanded items, the Infon Control Gutter doubles as a scroll bar. The figure illustrates that there is content out of view at the bottom of the Field with the arrow [1715]. Should the content be scrolled in a way that unviewed material is off the top of the Field, then control [1702] will be replaced with the upward twin of [1715].

Topoiesis Infons can in this manner have their Ontology Graph be fully explored. Any entry on the graph that appears in two linkage paths is displayed as an alias. One novel use of this view is to arrange a collection of facts under headers by dragging and dropping, perhaps from other Fields or linking from other Fields as described below. In that case, the user will have a number of sequential facts each under a header, By selecting “Hilbert Space” from Option Popup [1707], the outline view can be replaced by one in which each outline header [1709] generates a vector from the children under it. These are seen as Topoiesis Infon statements equivalent to right hand side expressions. Using the same process described in the discussion of FIGS. 4 through 11, each of these expressions generates the vector. The collection of such vectors displayed in Field [1701] defines a Hilbert Space in which all the defined vectors are well behaved.

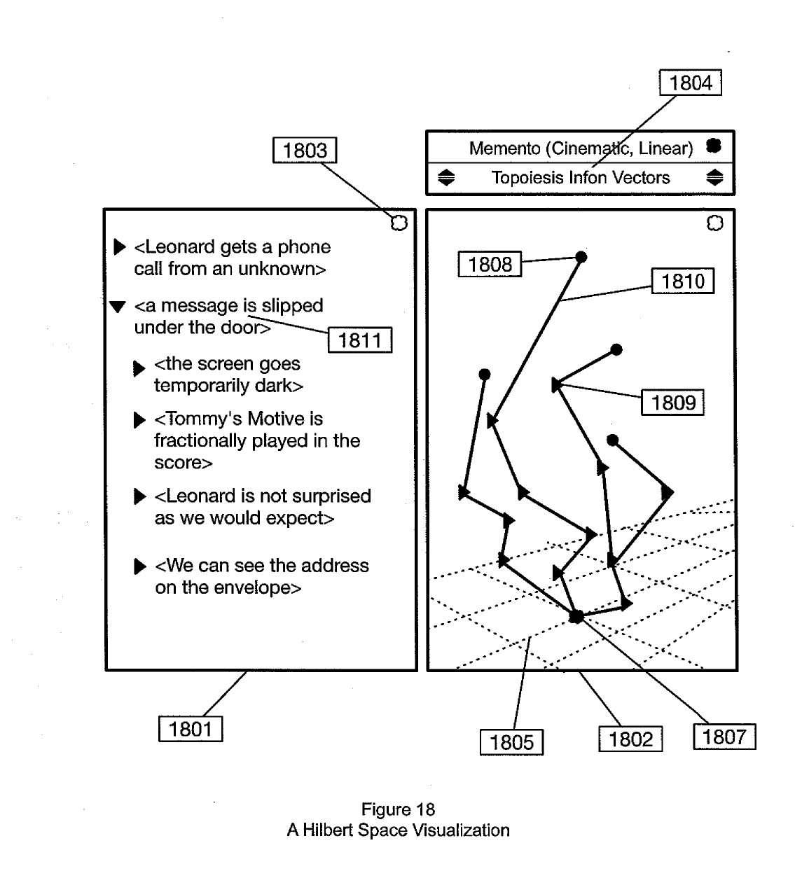

Hilbert Spaces are well known in the art and the vectorization of concepts in such spaces is as well, being a robust area of mathematics and mathematical logic for decades. The use of Hilbert Spaces for logical examination is common, and in fact underlies Google's MapReduce, so is invoked billions of times a day. The technique for generating situated vectors is novel and unique to the invention. FIG. 18 illustrates one possible, non-limiting means of displaying Topoiesis Infon Vectors.

The formatting of elements as outline constituents and vectors is performed at state [209] of FIG. 2 as previously described. The construction of the vectors is governed by the same set theoretic rules as previously described for Cell creation. Thus, a Topoiesis Infon Vector view in Hilbert Space is an intuitive means for manipulating inter-fact structures directly. Referring to FIG. 18, Field [1801] is identical to Field [1701] of FIG. 17 without its Label Field displayed. Field [1802] is an alias of Field [1801], containing the same structure and elements but with differing views. The status of the Field as an alias is denoted by the hollow Option Control [1803] in each Field. The popup that this control produces (not shown) will now include an option to highlight the sibling aliases.

Field [1802] has its Label Field shown and the Option Popup selection [1804] as shown: “Topoiesis Infon Vectors,” which is the Hilbert Space view. The view includes a Reference Field [1805] shown as a dotted grid. This is computed by State [213] of FIG. 2, representing the expressible situation parameters of the space defined by the applicable Situation Dynamics as determined by State [211].

Vectors exist in a three-dimensional space that can be zoomed and rotated as a three dimensional object using display and control techniques known in the art. [1806] is a typical vector. All vectors originate from the same point [1807]. Vectors have three types of control points. The originating point represents that fact that at the situated state when the facts are encountered, all the relevant ontological graphs are coordinated. The icon for that point [1807] doubles as a Display Popup Control for display options for the view. This display options popup is not shown in FIG. 18, and will contain view options related to the display techniques known in the art. Examples will be colors, latency, keyboard shortcuts and so on.

The Terminal Dot [1808] corresponds to the entry in the outline with such a dot. The dot is also a draggable item. Dragging the terminating dot from one vector to another has the effect of “adding” that vector to the target vector. The mathematical operation in Hilbert Space is a common inner product using the constraints of the defining space. The corresponding Infon operation is to create a composite Topoiesis Infon with the dragged Infon structure as the first part. This is likely to change the Functional Reactive Fabric of FIG. 11 and change both the nature of the space (the containing situations) via State [211] and the fact structures via State [207].

A Disclosure Triangle [1809] is shown at each node in the vector. These correspond exactly to the entries shown in Topoiesis Infon view. Toggling a disclosure triangle in the vector view, opens a Field with eth Topoiesis Infon outline if one is not already visible and opens the outline entries to the state indicated in the vector view. In this way, the detail of any vector is readily comprehendible. Note that the vector view is built on the outline structure as constructed on the left side of FIG. 17. Opening and closing Ontology Infons using controls on the right is available to a user to further understand the vector.

Vectors themselves are changeable. Using a number of known interface techniques, including haptic devices, a user can “grab” an element of the vector and move it within the space. A user may wish to do this to influence the relative effects of a Topoiesis Infon one to another or the effects between Topoiesis Infons and the governing situation dynamics. The former is managed at State [207] and the latter at State [211] as previously described. Haptic devices can provide the additional information about how strenuous the interpretation of a fact is. Such a technique can help a user determine the weak interpretations in a complex deduction. Alternatively, a user can 174 inearize and modify the situated context changing the Ontology Graphs, and therefore the Cells that generate the Functional Reactive Fabric. This is a powerful feature of the invention.

Vector [1810] in FIG. 18 corresponds to outline entry [1811]. The outline of FIG. 17 can be directly edited. Facts can be changed by direct edit, order of facts rearranged, and ontologies changed.

In the manner described in FIGS. 17 and 18 Facts can be envisioned in a situated context. Facts can be edited with awareness of the effect of changes in facts or enhancements in their interpretation. Situations can be modified and their effect on the interpretation of facts displayed.

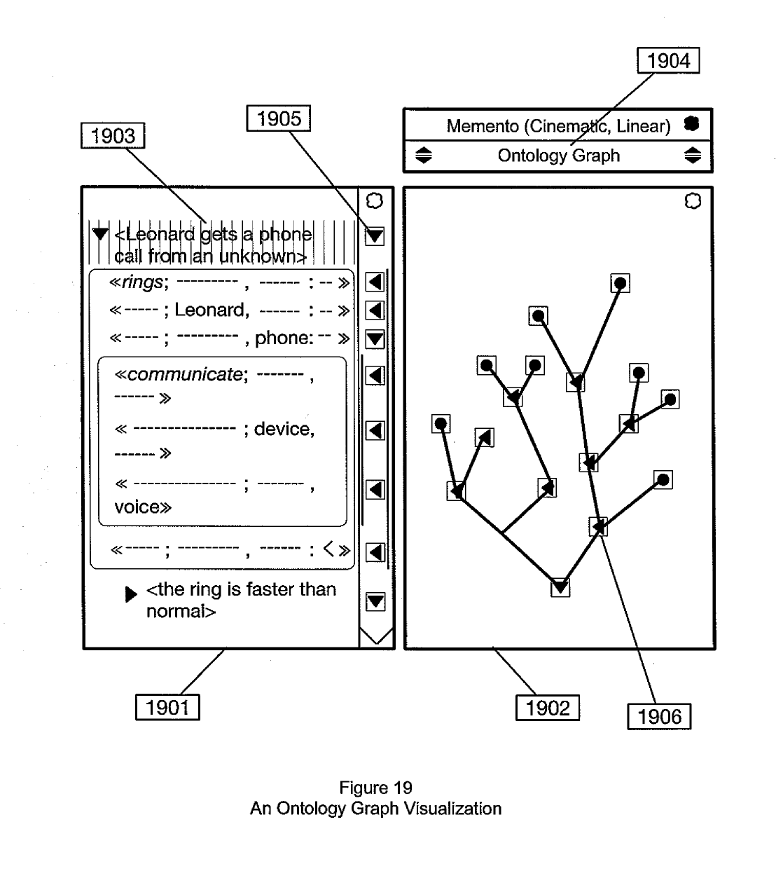

Turning now back to FIG. 17, the display of FIG. 18 mirrors the structure as created on the left side of the outline. The vectors depend on the Ontology Graphs for the generation of the vectors and space but FIG. 18 does not display the Ontology Graphs. FIG. 19 shows this.

Supposing now that the user working with the outline of FIG. 17 is exploring the Ontology Graph, using the controls in the Infon Control Gutter [1704]. A l75 linearized hierarchical display is good for tracing a single thread, but good for looking at the big picture. Just as the Hilbert Space view of FIG. 18 provides a combined big picture of the facts that apply to a given situation (a Field), so does the view illustrated by FIG. 19 provide a combined big picture of a relevant Ontology Graph. The user can choose in the outline Field of FIG. 17 to expand all the entries of an Ontology Graph. Alternatively, the user can select specific elements of Ontology Infons to display and trace by toggling the controls [1713].

FIG. 19 shows an example that is not limiting. As before, there are two linked Fields. The outline Field [1901] is similar to that of FIG. 17 [1701] except instead of exploring structure of Topoiesis Infons using disclosure triangles on the left, the user is exploring structure of Ontology Infons, using disclosure triangles on the right. Field [1902] is a mirrored Field with the partial Ontology Graph of the selected Topoiesis Infon [1903]. The selection is shown in FIG. 19 as hatching, though many highlighting conventions exist in the art. The described embodiment selects infons by click and hold, but many selection actions exist in the art.

The figure shows the normal case where only one Topoiesis Infon is selected for examination. The user can collapse and expand elements in Field [1901] of the Ontology Graph for selective display in Field [1902]. Should the user decide to see the entire Ontology Graph, an option click on the main disclosure triangle [1905] expands the entire Ontology Graph, though many commands for this operation exist in the art.

FIG. 19 shows Field [1902] with its Option Popup [1904] showing the selected display state: “Ontology Graph.” The Ontology Graph of the expanded elements is shown. As with the Hilbert Space view of FIG. 18, this object is a three dimensional object that can be rotated and zoomed. Selection conventions are the same as in FIG. 18: selecting one or more representative control object in Field [1902] reveals and highlights the corresponding outline entries in Field [1901]. Selecting one or more entries in Field [1901] highlights the corresponding nodes in the Ontology Graph.

In this way, full and partial Ontology Graphs can be examined and edited.

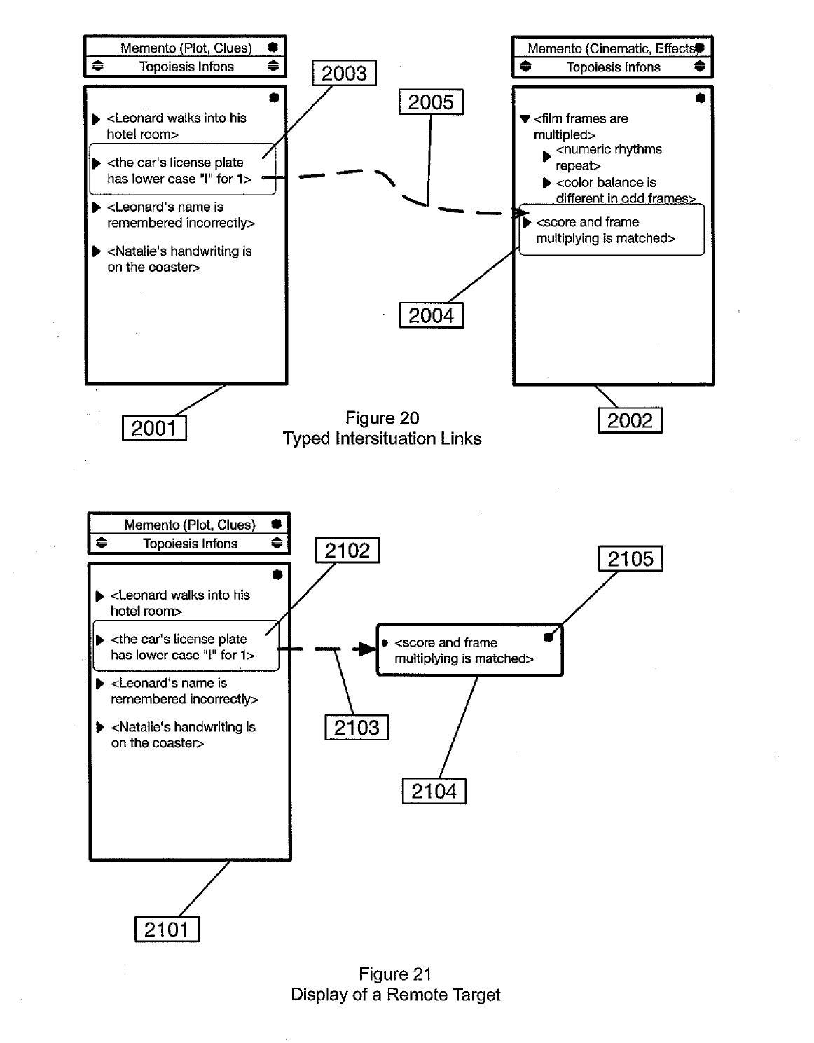

Outliners encountered in the art have one Field [1701], [1801] and [1901]. FIG. 20 illustrates the novelty of an outliner that has many Fields. FIG. 20 shows two independent Fields, though many Fields can be supported. In the described embodiment, Fields are associated with situations and the entries in outlines are facts. Thus, each Field that is displayed in the interface is a situation-theoretic equation [311] of FIG. 3. Entries are Topoiesis Infons, the Field is a situation. The figure shows them using the informal notation of [301].

Fields [2001] and [2002] have different source ontologies. Field [2001] notes facts derived from a movie plot as discerned by a viewer. In this non-limiting example, Field [2002] contains a list of cinematic effects that can be employed in any film. In the mode illustrated, the user will enhance the collection of information by adding a fact.

The process for adding a fact is illustrated in FIG. 20. The user selects a Source Item [2003] in a field [2001]. A Source Item can be one or more selected Topoiesis Infons, each Topoiesis Infon being at any level of the outline. Selection of Aliases is allowed. Alternatively, a Source Item can be any of a number of Ontology Infon entries, either entire Ontology Infons or components as illustrated in FIG. 19.

The user drags from one element of the selection [2003] to a selection [2004] in a Target Field [2002]. A link [2005] is created. A wide variety of indicators of such a link can be employed. In the described embodiment, the link is shown by a connecting line [2005]. On dropping the line on the target, a popup list (or other selection object) (not shown) provides for a means to assign a type to the link. Either the user can select from a selection of known types that are appropriate for the Source and Target items, or she can create a new type. In both operations, the system uses the combined Ontology Graphs as modified by the Functional Reactive Fabric to ensure that semantically correct links are created.

The link is stored in the system as a new fact. In FIG. 20, for example, the new fact that is created may be: “min the scene where we see that the license plate has a lower case ‘l’ where previously it had a 1>it is the case that at the same time the frame rate is increased and beats of the score match the frame rate increase>.” This forms a new Topoiesis Infon in the system, with the link as the relation, the Source element is the first parameter and the Target element is the second parameter.

This new Topoiesis Infon is handled in the system like any other. It at least inherits situation information for the Source and Target components. Ontological federation, if required, is handled automatically by the Functional Reactive Fabric as described.

By means not shown and well known in the art, a user can choose to hide or show these links in a multifield layout. They can be shown by type, by some situational quality, or by any means the user prefers. A multifield layout can consist of multiple windows on a monitor, multiple panes in a window, for example a web browser or some combination.

A multifield layout can be useful when information comes from diverse sources, has different root ontologies, is of different character or if information is to be viewed in different contexts, one field per context [situation].

FIG. 21 illustrates the case in a multifield layout where Typed Links exist but the field of the Target is not displayed. Supposing that the user has Field [2101] displayed, Topoiesis Infon [2102] selected and wishes to view Link [2103], either individually or as part of a group display. Link [2103] in this case does not have a Source in a displayed field. If it did, that Field's outline would expand to show the Target if it were collapsed, highlight the Target and display the Source [2102], Target [2104] and Link [2103] as shown in FIG. 20.

In the case where the Target Field is not visible, a window [2104] appears with the contents of the Target item. That window may float above other panes, windows or fields. There are many conventions in the art. The window [2104] can contain a control which allows the user to display the whole pane or reveal the top zone of the Field for detailed inspection.

It should be noted that the examples of FIGS. 20 and 21 illustrate outline to outline links, any of the described Field Views can contain a Source or Target. Typed links can be created within Fields. Any hierarchical nesting can be considered a link to be displayed across fields by restructuring situation views. An alias can be considered a type of link, and such Alias Links can be created across fields and view types. A Field can be invoked to be manually or automatically populated to contain links of a given type profile. A Field can also be created that lists all the Link Types, and this can be used, for example, as a control to show and hide link arrows.

Link Types can have dependent structure that can be shown in a Field, using any of the views described.

Links are like every other reactive element in the system. The creation of a new link adds new information to the cell generation process previously described, and therefore can substantially change the Functional Reactive Fabric with the results that many elements in the Ontological Graphs change. A result is that information that is displayed by various means will likely change within the displays.

Fields of other types are allowed. For example, an item of information may have originated in a printed document and it would be useful to display an image of the original document. Any media type supported by the Client hardware can be integrated into a multifield display. A typed link, for example, can be drawn from an entry in a Field to the source text in a document displayed in a pane that was used to generate that fact.

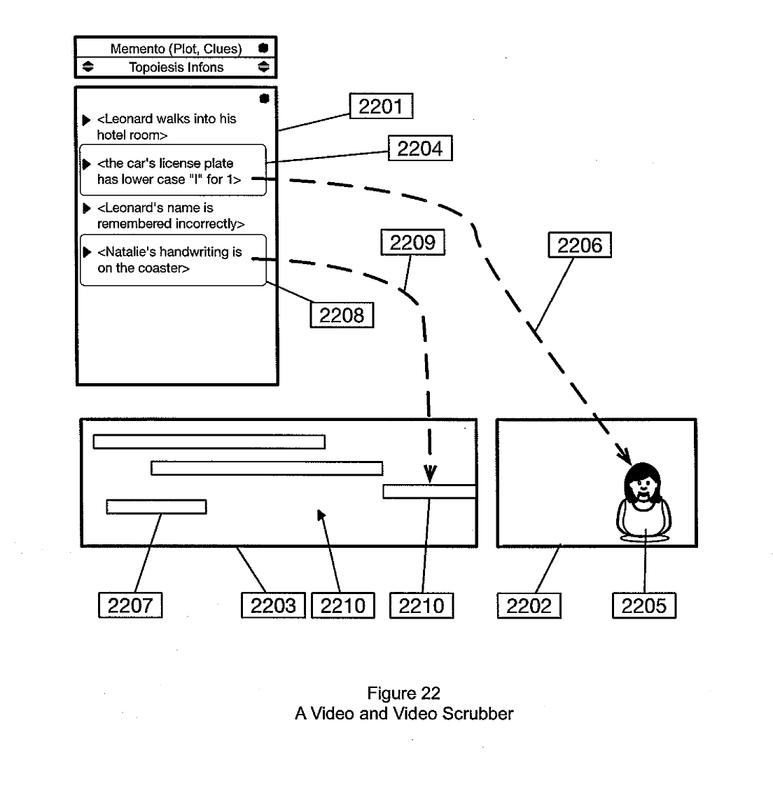

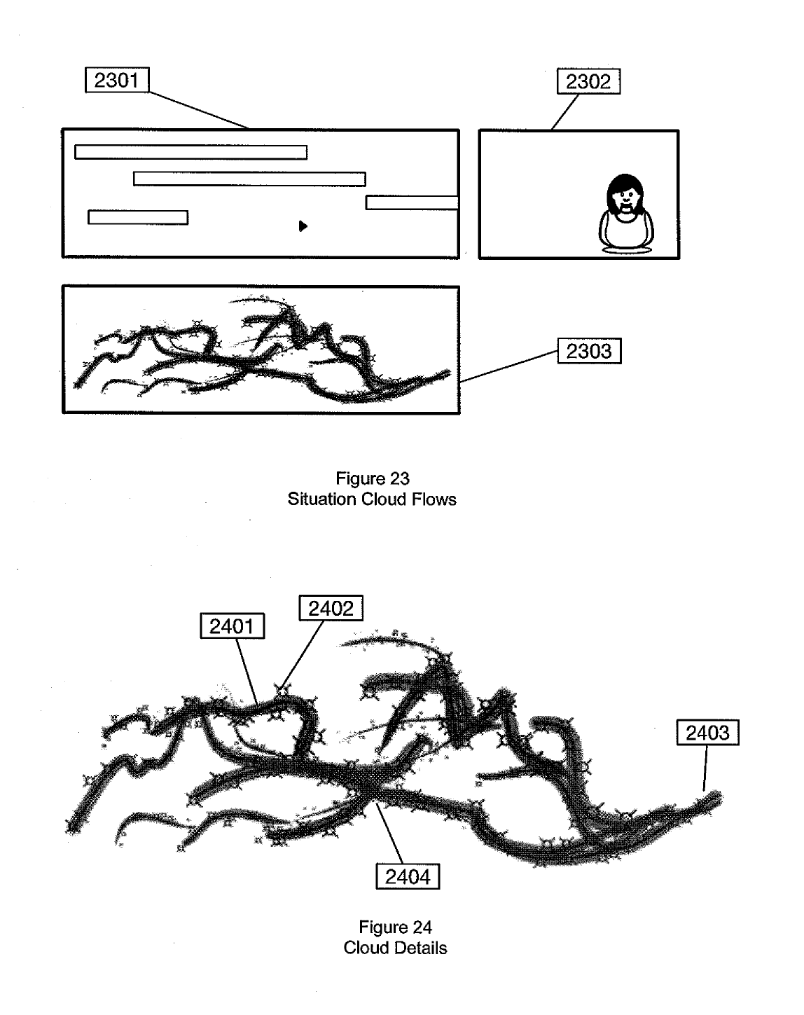

FIG. 22 takes this further. Field [2201] is identical to Fields [2003] and [2102] from previous Figures. In this example, it lists some items from a commercial film. The film can be played in a Field [2202] containing a video player using techniques known in the art. Such a player can stop a video to display a frame as a single image.

A user can create a typed link from an existing or new Source Item, for example [2004] to a Target Field [2202]. The Target Field if it is a video player, understands that the link is to a specific frame of the video. Should the technology be available to a user, an item within a media frame can be the Target, as shown in FIG. 22, Link [2206] has as its Target an object within the Field.

Field [2203] is a combination scrubber and sequence marker. This can be readily implemented using known tools in the art and many examples exist. Moving a cursor left and right internal to the Field “plays” the video backwards and forwards. During this, the displayed frame in Field [2202] will change. The links connected to a frame or objects within a frame will appear and disappear. Rods [2207] mark video sequences; the left end of the rod marks the frame that is displayed in [2202] when the cursor is at that location. The right end similarly marks the ending frame where the cursor [or other selection method] indicates.

In this way, a Field can represent video sequences and locations [2210] as objects that can be used to browse and annotate video. Moreover, they can be Sources and Targets for Typed Links. For example, FIG. 22 shows two Typed Links. Link [2206] may annotate a frame of a film to show that an observer in that frame seems to see a license plate differently than we do. This is an example of a Typed Link to an object. Link [2209] could illustrate an example annotation to a sequence in a film where we discover that a key message was written by an unexpected character. This is an example of a link to a specific segment [2210] of the movie.

By similar means, any streaming flow of information can be similarly annotated in such a way as to be integrated into the situated influence of the Functional Reactive Fabric. Non-limiting examples of streams of information are: videos, electronic message chains, such as found in email, Twitter™, RSS, phone conversations, sensor reports and manufacturing process flows.

What is claimed is:

1. A method of synthesizing object programming, functional programming and data-flow management in a distributed computer system to create a collection of data that is explicitly linked to qualifying contexts and the data is a collection of facts or inferences;
the distributed computer system is comprised of a client-server architecture with information stores, metainformation stores, information servers, topoiesis servers, and clients; and
the information servers are connected to topoiesis servers.

2. The method of claim 1 wherein Information servers connected to topoiesis servers via links that are chosen from the group comprising dedicated persistent links, opportunistic short-term links, or a combination of the two types of links.

3. The method of claim 2 wherein the information servers can be discrete or cloud based.

4. The method of claim 3 wherein the topoiesis servers perform reactive interpretation and situating of information.

5. The method of claim 4 wherein:
information is collected from information storage by information servers;
collected information is transmitted to one or more topoiesis servers;
clients are connected to the one or more topoiesis servers and clients transmit information to one or more topoiesis servers and, based upon the information from clients, the one or more topoiesis servers build reactive functions; and
the one or more topoiesis servers then perform reactive interpretation and situating of the information from the information servers.

6. The method of claim 5 wherein the topoiesis servers are connected to the clients via connections that are determined and managed by shared code in the clients and topoiesis servers.

7. Clients access information using common methods to access, fuse, evaluate, edit and create information, performing transforms and reasoning.

8. The method of claim 7 wherein the client has one or more default situations associated with it.

9. The method of claim 1 wherein the system learns from a client's past actions and creates additional situations to provide intelligent assistance.

10. The method of claim 1 wherein the method is reactive to changes in situations or enhancement of facts.

11. The method of claim 1 further comprising a structuring process wherein a collection of facts or inferences are explicitly linked to qualifying contexts.

12. The method of claim 11, wherein the structuring process comprises the steps of:
information entering the computer system,
the information is structured to be computable by states in the system and the system structure is topoiesis infons;
the infons are displayed as predicate, subject, object expressions; and
infons are assembled into expressions based upon situatedness.

13. The method of claim 12 wherein the expressions are transformed, based upon user-defined requirements, by a reasoning system and where the reasoning system is any task capable of being performed on a von Neumann/Turing Machine.

14. The method of claim 13 wherein the expressions are transformed based upon user-defined requirements, by a reasoning system and where the reasoning system consists of lazy evaluation techniques.

15. The method of claim 13 wherein the topoiesis infons can represent facts, collections of facts and inferences or results of transformative processes.

16. The method of claim 13 wherein the method further comprises the step of translating elements of state to elements that can be directly used by a user interface.

17. The method of claim 14 wherein the method is recursive.

18. A distributed computer system for providing reactive transformation of information, the system comprising:
a server, having a server memory configured to store information from an information source;
a server processor configured to perform a function on the stored information to create transformed information;
a communications device configured to transmit the transformed information;
a client, having a client communications device configured to receive the transformed information from the server;
a client memory configured to store received transformed information;
a client processor configured to perform a function on the transformed information to create further transformed information;
a display configured to display a representation of the further transformed information; and
wherein functions performed by the processors are performed using incremental computing and functional programming.

19. The system of claim 18, wherein the system further comprises a first signal to relate stored information with transformed information.

20. The system of claim 19, wherein the system further comprises a second signal to relate transformed information with further transformed information.

21. The system of claim 18, wherein the processors transform information by using functionally codable mathematical functions and avoiding state data.

22. The system of claim 18, wherein the client accepts a query.

23. The system of claim 22, the system further comprising a user interface coupled to the client, wherein the user interface can accept the query.

24. The system of claim 22, wherein the processors transform information and further transform information in relation to the query.

25. The system of claim 24, wherein further transformed information is only processed if it is dependent on the query or the transformation of information.

26. The system of claim 18, wherein changes to stored information will force the processors to re-perform functions on all transformed information and further transformed information dependent on the stored information.

27. The method of claim 1, the method further comprising:
using a server processor to perform functions on a stored information to create transformed information;
using a client processor to perform functions on the transformed information to create further transformed information;
using a first signal to represent the relationship between stored information and transformed information;
using a second signal to represent the relationship between transformed information and further transformed information;
using a client processor to create and display results in the context of methods;
wherein the server and client processors use functional computing, the transformed information and further transformed information is incrementally computed.

28. The method of claim 27, further comprising:
receiving a query;
responding to the query comprising:
creating a third signal representing an expression based on the query;
determining if the expression has been responded to;
determining if the expression is a function application where the expression has not been responded to;
determining if the expression is a lambda expression where the expression is a function application,
performing a beta reduction where the expression is a lambda expression;
evaluating at least one input to the expression by performing the at least one function on the stored information to create the transform of information.

29. The method of claim 28, further comprising:
using the first signal to update transformed information when stored information changes; and
updating the first signal.

30. The method of claim 27, further comprising:
using the second signal to update further transformed information when transformed information changes;
and updating the second signal.

31. A distributed system for providing reactive transformation of information, the system comprising:
a server, comprising:
a memory configured to store information from a plurality of information sources;
a processor configured to transform stored information from at least one of the information sources by applying a first function; and
a communication device configured to transmit the transformed information;
a client, comprising:
a communications device configured to receive the transformed information;
a processor configured to further transform at least some of the transformed information by applying a second function; and
a display configured to display a representation of the further transformed information to a user, wherein at least one of the first and second functions is applied based on a user query and the server processor is configured to automatically update the transformed information by again applying the first function when the information from the at least one information source changes.

32. The system of claim 31, wherein the server memory is further configured to store a dependency record of the information upon which the transformed information depends.

33. The system of claim 32, wherein the server processor is further configured to automatically update the transformed information by again applying the first function only when the dependency record indicates information upon which the transformed information depends has changed.

34. The system of claim 31, wherein the first function comprises a computation tree constructed from a plurality of template functions based on the user query.

35. The system of claim 34, wherein the computation tree is partially constructed by the client processor.

36. The system of claim 31, wherein the server and the client are the same physical computer.

37. The system of claim 36, wherein the display contains information about functional relationships from information the first signal and ontological references.

38. The system of claim 31, wherein the display of the computation tree provides affordances to allow modification of ontological context.

39. The system of claim 31, wherein the display of the computation tree provides affordances to allow modification of the functional array.
